(19) United States
(12) Patent Application Publication
(10) Pub. No.: US 2014/0297311 A1
(43) Pub. Date: Oct. 2, 2014

(54) HEALTH CARE RESEARCH, MANAGEMENT AND DELIVERY SYSTEM

(71) Applicant: BECKY L. JACKSON, Minneapolis, MN (US)

(72) Inventor: BECKY L. JACKSON, Minneapolis, MN (US)

(21) Appl. No.: 14/305,149

(22) Filed: Jun. 16, 2014

Related U.S. Application Data
(63) Continuation-in-part of application No. 10/311,198, filed on Jun. 6, 2003.
(60) Provisional application No. 60/211,380, filed on Jun. 14, 2000.

(51) Int. Cl. G06F 19/00

(52) U.S. Cl. CPC G06F 19/3431; G06F 19/36
USPC 705/2

(57) ABSTRACT

A health care management and delivery system includes a hosted environment that provides health care treatment, diagnosis, and/or management. Health care providers are linked to one another and to a central network, which is linked to patient via the hosted environment. The patient interfaces with the hosted environment, which includes hosted algorithms approved by the provider network. The patient may also have medical devices that facilitate collection of vital sign data (e.g., digital thermometer) and administration of treatment (e.g., medicine dispensary). The health care provider can license the hosted environment to deliver health care services remotely based on globally standardized protocols. The hosted environment includes all patient health records and information which can be accessed globally. The hosted environment conducts data analytics to continuously improve and add new standardized protocols. Additionally, a virtual clinical research organization (CRO) is provided, such that treating physicians and patients can participate in clinical trials and registries and have access to new medical treatments and improved safety and outcomes.

This application is a continuation-in-part of U.S. patent application Ser. No. 10/311,198, filed Jun. 6, 2003, which is a national stage entry of, and claims priority to, PCT/US01/14856, filed Jun. 14, 2001, which claims benefit of and priority to U.S. Provisional Application No. 60/211,380, filed Jun. 14, 2000, and is entitled to the benefit of those filing dates for priority in whole or in part. The specification, figures and complete disclosures of U.S. Provisional Application No. 60/211,380, PCT/US01/14856, and U.S. patent application Ser. No. 10/311,198 are incorporated herein by specific reference for all purposes.

### FIELD OF INVENTION

The present invention relates to a system and related methods for researching, managing and delivering health care to one or more patients. More specifically, the present invention relates to delivering health care services via an application service provider (ASP) that is secure, remotely accessible and globally standardized.

### BACKGROUND OF THE INVENTION

In the related art, health care treatment systems require physical or non-networked interaction between a patient and health care provider. For example, but not by way of limitation, a patient must make an appointment to visit a health care provider (e.g., physician) in order to obtain treatment. In the prior art, any coordination between health care providers is conducted on an ad hoc basis, and there is no standardization or coordination. Further, the patient's knowledge about his or her own condition is not included, and there is no structure in the prior art system for collaborative effort or informed patient direction or participation in his or her medical care and treatment.

Further, each health care provider is disaggregated from other health care providers, such that if a patient requests diagnosis and/or treatment by a health care provider who did not participate in prior treatment, there is no prior art system to provide this treating physician with the prior treating physician's expert knowledge about the prior treatment, because health care providers are not interconnected. The prior art system does not provide any reimbursement or other incentive for health care providers to interconnect their services with one another so as to provide a community of service to the patient. The only incentive is good will to foster referrals, which does not promote treatment by other physicians on a large-scale, standardized level. It is also a disadvantage of the prior art that there is also no central repository for treating health care providers' knowledge, experience and expertise related to a patient that can be accessed either by subsequent treating providers or the patient.

FIG. 1 illustrates the prior art system of heath care treatment. In a pool 1 of health care providers 2a . . . 2g, none of the health care providers are interconnected to one another or to a common central station. The prior art system has various problems and disadvantages, including, but not limited to, non-standardization between health care providers. For example, but not by way of limitation, a first health care provider 2a may be located in a first country (e.g., United States), whereas a second health provider 2b may be located in a second country (e.g., United Kingdom), and due to the currency barrier, the first and second health care providers 2a, 2b cannot interface with one another to treat patients who may be working and/or travelling abroad. Also, where a patient has traveled from the first health provider 2a (e.g., in the United States) to a third health care provider 2c in a third country (e.g., Nepal), the health care providers 2a, 2c cannot interface due to a lack of standardization in health care management, diagnosis and/or treatment.

Further, a fourth health care provider 2d located in a first state (e.g., Michigan) and a fifth health care provider 2e located in a province of a nearby country (e.g., Ontario) may not be able to interface due to a difference in currencies and currency exchange rates. Additionally, a sixth health care provider 2f and a seventh health care provider 2g may not be able to communicate with another due to individual providers having different languages, protocols, or licensing credentials, even if they are in the same jurisdiction. Thus, a need exists for standardization that has not been met due to various inherent barriers of the prior art.

An additional barrier to standardization is licensure requirements. Currently, a health care provider in the United States is licensed on a state-by-state basis. Only licensed health care providers may provide medical care and treatment in accordance with state licensure. There is no structure by which patients can be treated on a hosted remote ASP basis. Additionally, it is not possible for the national expert licensed in state A to treat patients out of state unless the patient travels to state A, and as noted elsewhere in the application, there is no remote treatment of patients in the prior art. In additional to the health care providers 2a . . . 2g in the pool 1 not being able to communicate with one another, they are also not able to communicate with the patients 3a, 3b without intermediate steps. For example, but not by way of limitation, a patient 3a may have to make an appointment in order to receive diagnosis and/or treatment from the first health care provider 2a in the United States, and thus may not be able to receive treatment at a time when an appointment is not available, especially in non-emergency instances.

Further, when stationed overseas, it is not possible to make such and appointment, and for the above-mentioned reasons, it is difficult for a patient's 3b health care provider 2a to communicate with a health care provider (e.g., 2b in Britain). Thus, the patient 3b may receive an inadequate level of care, and harm may result due to increased time delay or cost in interfacing the patient 3b to an available health care provider 2b in the pool 1.

Also, due to varying standards and regulations, various health care providers 2a . . . 2g of the pool 1 may not be able to interface with emergency/hospital care 5 or pharmacy/drug store 7, thus further reducing the global availability of treatment For example, but not by way of limitation, the second patient may be stationed in a country having a different standard of medical care, where hospital and emergency treatment may not be standardized, and drug availability may be low. As a result, a life-threatening situation may result from an otherwise easily treatable condition if a patient does not have access to certain medication or services that provide the requisite treatment in the home country of the patient.

In the prior art system, clinical research organizations (CRO's) are created for the purpose of conducting clinical trials on new medical devices, procedures or pharmaceutical products awaiting regulatory approval for commercial use. The clinical studies involve selection of a study group of patients, who participate in the study and provide results to the clinical investigators conducting the study. In the prior art CRO, each CRO must solicit physician and patient participation, screen for qualification and oversee performance of clinical studies. These CRO functions are performed primarily on a person to person, telephone and paper basis.

Further, once the new medical treatment has been approved for experimental use, most physicians do not have access that would allow qualified patients to gain access to the benefits of the new medical treatment. As a result, qualified patients are denied access to participation in studies and/or obtaining benefits of those studies (e.g., new experimental drugs) due to lack of large-scale, coordinated access and also due tight controls on participation.

Presently, converging market factors include a large baby boom population of well-educated consumers having high demands for health care, along with a backlash against managed care, as seen in the class action lawsuits against HMOs, escalating premiums and employers looking for new strategies with regard to the self-funded population. Certain large self-funded employers, such as Xerox, are providing vouchers to their employees for health care services and letting them develop their own customized health plans. Increasing questions about reimbursement present additional pressures on the industry. Hospital/physician integration initiatives have failed, as have physician practice management companies. Offloading risk to providers has also generally failed as a strategy for payors. As a result, there has been a significant movement away from risk-based compensation. In some parts of the country, capitation and risk pools are still in use. But in many ways, risk compensation resembles fee-for-service compensation in that the pressure is downward.

A prior art example is an Independent Practice Association (IPA) that had a provider participation contract with a managed care organization that included a full-service (primary care and specialty) physician service component along with hospital risk-based compensation. The managed care organization was bought by a national HMO, which renegotiated the terms of the agreement by demanding a primary care capitation arrangement in the low double digits per month. Although the level of compensation was grossly inadequate even when limited to primary care providers, these are the terms on which national payors are insisting. The process for negotiating risk-based compensation is no different from negotiating how much a payor will compensate a physician on a fee-for-service basis. As noted above, current physician reimbursement strategies then lock physicians into a paradigm in which physician income is based solely on the number of patients that can be seen or the number of procedures that can be done in a given day.

The Internet is becoming such a major new trend as both a delivery mechanism for e-commerce and content, as well as a very time efficient communications tool, which allows patients and physicians to be in more immediate communication on their own time, as distinguished from conventional telephone communication, where two people are simultaneously on the line. The possibilities are further demonstrated by the whole Internet business-to-business initiative and the growing receptivity to and applications for telemedicine, along with the creation of and movement toward the creation of electronic medical records and Internet security.

The Internet also makes disease management more efficient and affordable. Pharmaceutical companies and other health care entities are attempting to shift disease management functions from paper and telephone to the Internet as a much less expensive but as effective (or more) means than telephone or paper communications. The current physician community remains a very fragmented part of the market, and consumers ultimately have to go to their own physicians for health care. Doctors typically practice alone or in very small groups, and even highly paid specialists are under a lot of economic pressure with very limited time. The Internet initiative provides access to some major powerful, well-heeled players on the direct-to-consumer initiatives, particularly on content and care and treatment side of health care, as well as business applications for consumers and physicians, and a system that oversees and standardizes care and treatment via the Internet.

However, a key missing link in these developments is the actual treating physician and the interface between the business-to-business national players, the treating physicians, and the physicians' own patients. For example, if a patient visits WebMD on the Internet and gets information about health care and the consumer, the patient still needs to go back to his treating physician to actually apply that information (i.e., treatment) and to make the diagnosis and issue the requisite orders.

Thus, there remains an unfulfilled need for a system and method for creating an integrated medical network that efficiently and securely delivers health care.

### SUMMARY OF INVENTION

An object of the present invention is to provide a system and method for creating a community medical network through collection, distribution and use of information in connection with health care delivery.

Another object of the present invention is to provide a web-based information distribution system that supports the efficient and secure interfacing between treating physicians and their patients.

Another object of the present invention is to link national e-providers and sponsors with community physicians and their patients.

Another object of the present invention is to create virtual physician-driven organizations at the community level comprising a physician oversight mechanism and a network of Internet-linked physicians.

Another object of the present invention is to compensate physicians to manage care and, as medically appropriate, diagnose and treat patients via the internet.

Another object of the present invention is to compensate physicians continually to identify and integrate into community health care delivery systems standards of practice, protocols and non-face to face treatment, diagnosis and preventive health modalities.

Yet another object of the present invention is to provide a virtual clinical research organization (CRO) that can allow health care providers and patients to participate in clinical trials and registries and gain access to new medical treatments.

To achieve these and other goals and objects, a method of delivering health care services in a networked environment is provided, comprising the steps of receiving a health care treatment request having at least one parameter from a user to a hosted environment, and said hosted environment generating with the networked environment health care diagnostic, treatment and/or management instructions in accordance with said at least one parameter. The method further comprises providing at least one of said user with said health care diagnosis, treatment and/or management instructions, and remotely treating a patient in accordance with a standardized level of care and at least one of said provider's instructions.

Additionally, a hosted system that provides a patient with health care diagnosis, treatment and/or management is provided, comprising a sponsor network that determines at least one component of said hosted health care diagnosis, treatment and/or management and integrates said at least one component to generate at least one standardized health care diagnostic, treatment and/or management practice. The system also comprises a treatment network that conducts credentialing of health care providers, audits and monitors said hosted system and health care providers, and performs said health care diagnosis, treatment and/or management in a networked environment, further comprises a client enrolled in said hosted system and interacting with said health care diagnostic, treatment and/or management network through an user interface to provide said health care treatment and administration remotely from said health care providers in accordance with said at least one integrated component having said at least one standardized health care diagnostic, treatment or management practice, and facilitates audit oversight and administration of a health care finance and treating provider reimbursement for participation in the remote networked delivery system.

Further, a system that provides health care diagnosis, treatment and/or management to a patient is provided, comprising a request, generated by an user, received by an application service provider (ASP), said user request comprising a plurality of parameters, said ASP hosting a health care diagnostic, treatment and/or management instruction transmission to said generated by a health care network, said health care network including at least one health care provider. The system also comprises a health care diagnosis, treatment and/or management instruction output from said ASP to said user, wherein said health care diagnosis, treatment and/or management is performed remotely from said health care provider in accordance with at least one of said health care diagnostic, treatment and/or management instruction and feedback from said user.

Also, a method of performing clinical research and post-market surveillance is provided, comprising enlisting and administering provider participation in research and/or surveillance, enrolling a patient in a hosted, health care network, generating a multigenerational family history in a profile of said patient in said health care network, identifying whether said patient is a candidate for clinical research or surveillance, inviting said patient to participate in said clinical research or surveillance, enrolling said patient upon patient's acceptance of said invitation, and conducting said clinical research and surveillance with providers and patient in a networked, hosted environment.

### BRIEF DESCRIPTION OF THE DRAWINGS

The accompanying drawings, which are included to provide a further understanding of preferred embodiments of the present invention and are incorporated in and constitute a part of this specification, illustrate embodiments of the invention and together with the description serve to explain the principles of the drawings.

FIG. 1 illustrates a prior art health care system for diagnosing, treating, and managing patients.

FIG. 2 illustrates a health care system according to a preferred embodiment of the present invention.

FIGS. 3a and 3b illustrate a method for performing health care services according to the preferred embodiment of the present invention.

FIG. 4 illustrates a method of designing, building and managing health care services according to the preferred embodiment of the present invention.

FIG. 5 illustrates a method of creating and operation a clinical research organization (CRO) for a patient according to the preferred embodiment of the present invention.

FIG. 6 illustrates a method of creating and operating the CRO for a physician according to the preferred embodiment of the present invention.

FIG. 7 illustrates an overview of the architecture of the preferred embodiment of the present invention.

FIG. 8 illustrates the relationships between various entities and services according to the preferred embodiment of the present invention.

FIG. 9 illustrates the networks and functions of the preferred embodiment of the present invention.

FIGS. 10a and 10b respectively illustrate first and second phases of developing a Community Medical Extranet according to the preferred embodiment of the present invention.

FIG. 11 illustrates a revenue model according to the preferred embodiment of the present invention.

FIG. 12 illustrates functions of various parts of the preferred embodiment of the present invention.

FIG. 13 illustrates an exemplary disease management and prescription drug benefit program according to the preferred embodiment of the present invention.

FIG. 14 illustrates an overview of an electronic health system in accordance with an embodiment of the present invention.

FIGS. 15a and 15b illustrate a method of providing acute care in accordance with an embodiment of the present invention.

FIGS. 16a and 16b illustrates a method of managing the provision of healthcare services in accordance with an embodiment of the present invention.

FIG. 17 illustrates a virtual medical staff arrangement for an electronic health center in accordance with an embodiment of the present invention.

FIG. 18 illustrates a consumer participation arrangement for an electronic health center in accordance with an embodiment of the present invention.

### DETAILED DESCRIPTION OF EXEMPLARY EMBODIMENTS

Reference will now be made in detail to the preferred embodiment of the present invention, examples of which are illustrated in the accompanying drawings. One of ordinary skill in the art can extend the present invention to other online systems.

In the present invention, the terms are meant to have the definition provided in the specification, and are otherwise not limited by the specification. In this invention, the terms “manages,” “managing” and “management” refer to a patient receiving healthcare, instructions for obtaining healthcare, or administration of healthcare services, healthcare financial benefits, or the invention and all of its components and functions.

In several embodiments, the present invention comprises the following features. An Internet health care delivery system is provided that includes automated healthcare delivery, benefit and finance, data collection, creation and maintenance of patient's health records (PHR), and analytics and research. The term “healthcare” includes, but is not limited to, diagnosis and treatment, as well as disease, case and health management, care coordination, healthcare finance, health care economics, comparative effectiveness, data collection, analytics and research, and other items and services not currently typically covered by insurers, such as wellness, disease management, remote monitoring, experimental items and services, cosmetic care, acupuncture, and the like.

Additionally, a system is provided for the hosting of automated research, clinical research, post-market surveillance, treatment, diagnostics and triage protocols, disease management, care pathways, patient compliance reminders, remote monitoring, outcomes, quality of life and patient satisfaction surveys, pre-approved orders, healthcare management tools, data capture, storage and analytical tools, automated report generation and PHR generation using a universal standardized methodology that can be accessed by patients and providers, as well as provider-to-provider clinical care management, including access to real time data regarding the patient's current condition and compliance with healthcare treatment, outcomes, management and appropriate use of the invention. The system utilizes remote monitoring and diagnostic devices, wireless mobile applications, imbedded wireless modules, bionics, home tests, compliance programs and incentives to capture real data on a 24-hour, 7-days-a-week basis. The system automatically processes the data against hosted protocols, critical pathways and other algorithms to automatically deliver health care services to patients.

Also, the present invention includes automated provider network management, direct to patient provider products (such as discounts, concierge services, subscription or monthly payment models) credit arrangements, network rentals and customized provider network configurations (e.g., a Spanish speaking network or a specialty network, local licensure rented for consultations), automated Internet-based provider credentialing, and provider quality oversight and report cards.

In the present invention, internet health care financing is conducted so as to maximize benefit design, optimize payment for premiums/subscriptions, and easy management of medical savings accounts. In the present invention, a patient can design or customize a personalized health care benefits package, perform comparison shopping for specific health care products and services, and for health care finance packages, including insurance and retail self-pay options. The present invention also comprises online organization of supply chain procurement/shopping from group purchasing organizations, manufacturers, distributors and other suppliers for patients and providers.

Other aspects of the present invention include, but are not limited to, performance of online automated research, clinical research, post-market surveillance and tracking of costs, comparative evidence and patient outcomes and experiences. The invention automatically identifies, consents and enrolls providers and patients in the clinical trial or post market surveillance registry, automatically tracks and captures healthcare data on a 24-hour, 7-days-a-week basis for each enrolled patient and provider utilizing the components of the system in compliance with hosted protocols, stores data, conducts data analytics and issues reports.

In several embodiments, the system of the present invention is a web-based integrated medical network that utilizes micro-processors to automatically, efficiently, and securely collects, distributes, analyzes, and formulates healthcare services within the system to achieve automated health care management and services. It also links providers into care management teams that use the system to co-manage all aspects of a patient's care. For example, the system would link providers and appropriate automated critical pathways, standards of care, protocols with an endocrinologist, obstetrician, nutritionist and nurse mid-wife to manage the healthcare of a pregnant woman who is diabetic.

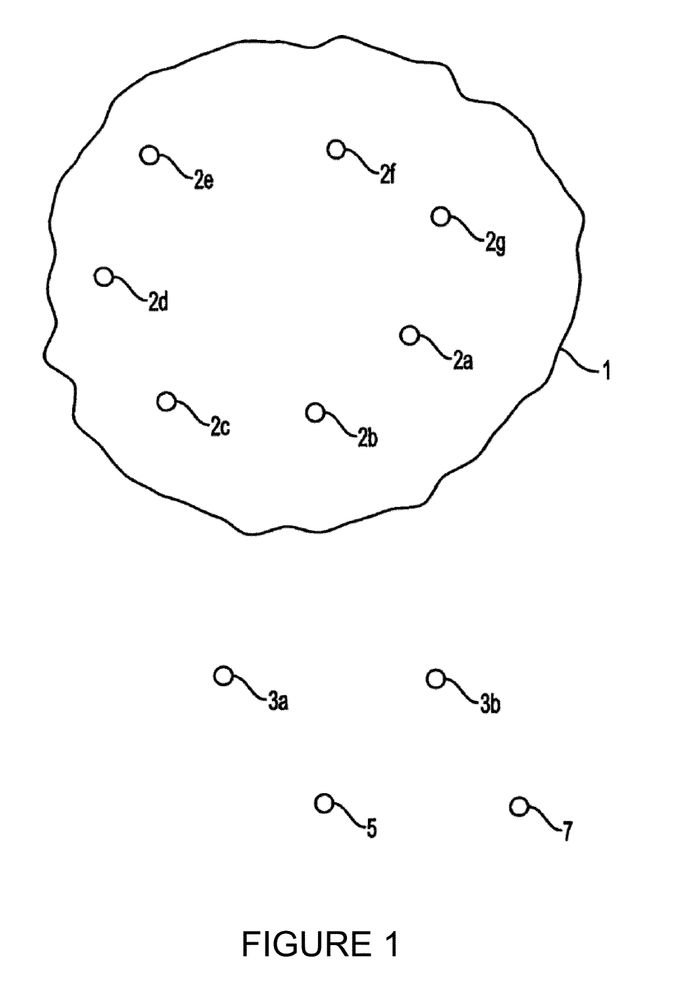

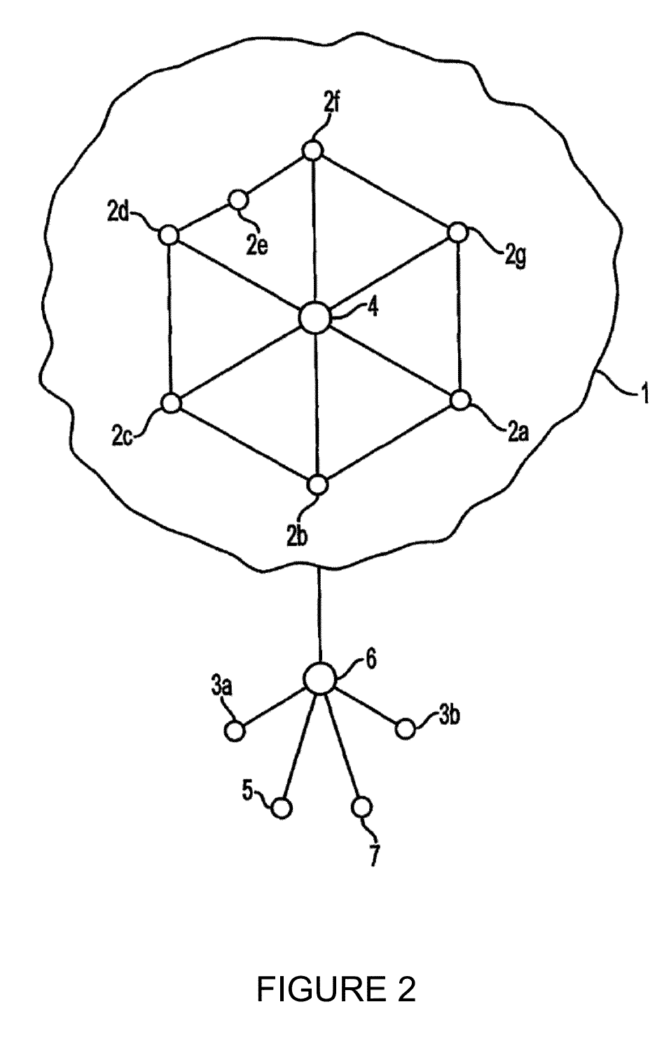

In the present invention, an Application Service Provider (ASP) is located in a hosted environment or the cloud, and performs automatic independent delivery of health care services to the patient that has been pre-approved by and is automatically reported to the health care provider. As illustrated in FIG. 2, and in comparison to FIG. 1, the ASP of the present invention includes a health care provider network 4 and a sponsor network 6. The health care provider network 4 is coupled to participating health care providers 2a . . . 2g in the pool 1, and is coupled to the sponsor network 6, which also commonly interfaces with the patients 3a, 3b, the emergency care network 5, and the supply network (e.g., medication and medical devices) 7. The system connects with and hosts automated health care delivery and finance tools (e.g., mobile applications, bionics, imbedded wireless modules, visual and audio recording applications, hand held devices, patient self-reporting tools and other means) to capture data in a standardized format that is fed into the protocols, standards of practice, critical pathways hosted in the system which deliver healthcare instructions and services to the patient, and a report of such services to the patient's provider team. The system may prompt the provider to initiate healthcare services to the patient and/or upon receipt of the report, the provider may initiate the system to automatically deliver healthcare services to the patient, such as utilization of a hand-held diagnostic device, medication change, and new prescription or direct the patient to seek additional services. Working together, the components of the system create an artificial intelligence system that can continuously monitor the application of the clinical pathways, protocols and standards of care, along with patient use of the system and the collected data to identify patterns, potential causation, performance of drugs and devices and other healthcare services and items and initiates updates and changes to the critical pathways, standards of care, protocols and patient support and compliance tools based upon tracked outcomes and deviations noted by the system.

The sponsor network 6 identifies the necessary components of an automated internet health care delivery system (e.g., but not limited to hardware, hand-held devices, software, disease management programs, wireless mobile applications, imbedded wireless modules, bionics, health care finance and insurance companies and products), and develops or outsources those components by issuing requests for proposals (RFPs), negotiating contract terms with qualified bidders and managing the contractual arrangements. The sponsor network 6 also integrates each of the components into a seamless internet health care delivery and reimbursement/finance system, and automatically manages that system. The sponsor network also hosts pathways that triage patient access to the healthcare system in the most efficient manner. For example, if the patient injures his arm and an x-ray is needed, the patient is prompted to obtain the x-ray first and directed to a radiology center or instructed to utilize a device to diagnose the injury. The system reads the x-ray or device output and instructs the patient and appropriate provider as to the result, and if the arm is broken the patient is directed to treatment.

The hosted system automatically organizes and manages the health care provider network 4 composed of treating physicians and other providers in each community as an internet medical staff. The system automatically administers the credentialing and physician participation requirements, relevant bylaws and rules and regulations and automatically conducts peer review, medical audits and outcomes studies and monitors the providers for effective utilization of the system. In order to participate in the internet medical staff or network, physicians and other providers must agree to use the system and incorporate the medical standards of practice, protocols, electronic medical record functions and medical management systems into their office and hospital practice. The system maintains and manages the data, results of these functions and the PHR.

The system organizes, integrates and manages the sponsor network 6 which develops and administers a financial reimbursement/compensation system for treating physician and other provider participation in the internet delivery of health care. The system tracks health care delivery data, including costs, outcomes, provider encounters, devices, drugs, biologics and automatically administers reimbursement methodologies, including gainsharing, bundled payments, pay for performance, capitation and other models. In addition, the system automatically manages the administrative functions (e.g., eligibility determinations, insurance claim submissions, appointments, and patient care communications) via the Internet and hosted environment.

The ASP/system enrolls patients into the internet health care delivery system. The sponsor network is the central control for all patient internet communications. For example, but not by way of limitation, the sponsor network 6 with the input and approval of the provider network 4 designs, maintains, and operates drop down, “point and click” standardized patient healthcare management tools that incorporate the standards of practice, care pathways and protocols for the internet care health delivery system. The patients access and utilize the tools in the hosted environment, inputs data into the standardized tools, the system applies hosted standards of care, critical pathways and protocols to the data and delivers the healthcare service (diagnoses, treatment direction, monitoring result, care management direction) to the patient in the hosted environment. In addition, the sponsor network 6 develops and administers the health care financing systems for patients participating in internet health care delivery system as well as patient incentive programs. Patients can pay out of pocket and use a shopping cart approach or medical savings plans or health care benefits adapted to cover the internet health care delivery system. Patients programs to incent use of the system can include payment, points, reduced co-payments or deductibles or other rewards.

Additionally, the patient 3a, 3b may attach medical devices to interface with the sponsor network 6. The medical devices may include, but are not limited to, thermometers, sphygmomanometers, scopes with cameras controllable by the system or health care provider and/or sponsor network, blood testing devices (e.g., glucose meter or white blood cell count), pallor indicators, scans, mobile applications, and imbedded wireless modules, bionics, sensors, or similar devices that can provide an analog or a digital or wireless signal that is used by the system to automatically deliver health care services (diagnosis, treatment, care management) to the patient.

Because a patient's licensed physician or other provider can deliver healthcare services independently of personal intervention or physical location, the present invention overcomes at least the prior art problems and disadvantages of lack of care coordination or management, language, protocol and currency barriers. In particular, health care services can be delivered to the patient by the system without prior review by a physician or health care provider. Further, the medical devices applied by the patient (which may be delivered by a delivery service if the patient does not own any medical devices) permit completely virtual medical health care that does not require any interaction with a live person either directly in person, remotely or via e-mail communications prior to the delivery of the healthcare service, where the quality and efficiency of service is better than in-person health care, due to the reduction in time delay and the elimination of the need for in person interactions and costly non-standardized or duplicative practices. In addition, the system automatically captures the data and personal health record in a standardized format which enables the system to perform automated research and post-market surveillance and capture longitudinal outcomes regarding the clinical, quality of life and economic value of healthcare services, including drug and device therapies.

Similarly, the medical devices may also be operated automatically based on a hosted command or direction from the health care provider. Such medical devices include, but are not limited to, metered medicine dispensers having an electronically adjustable rate, robotic devices to perform remote surgery, hand held CAT scans, or other interactive devices to diagnose, treat and manage patients outside of the presence of the health care provider. In addition, the system can receive data from devices, including implanted device, evaluate the data based upon hosted protocols, approved by the provider network and issue reports of the results of the evaluation to the patient and the provider.

To overcome various problems and disadvantages of the aforementioned prior art systems, the preferred embodiment of the present invention is standardized at a global level across language, currency, health care access network, and medical care protocol, healthcare services and items.

The preferred embodiment of the present invention creates an infrastructure that will automatically create a secure real time computable data base and PHR that includes the medical history, patient's DNA mapping, and other related data, integrated with state of the art information and human expertise/support regarding medical conditions, treatment and diagnosis that contains real time data regarding the patient that can be accessed by the patient, providers or payors at any time or any place via computers, tablet, pads, telephones or other mobile devices. Patients may have personalized websites at which their entire health/medical history is stored that can be accessed from any remote site. For example, but not by way of limitation, as gene mapping becomes an integral part of a patient's medical record, the information would be stored at the individual's personal health care site. The information includes family histories, including the patient's and parents' genetic maps and health histories. The invention thus can create a risk profile by maintaining an electronic medical history and/or performing genetic tests to map the genes of the patient and reviewing the patient's genetic history via a family tree. The invention also can access those records on a world-wide basis across countries in a standardized manner, and collect and collate standardized data so as to supplement said records. This data can be used by the system to determine the patient's risk of disease, health care disease management and prevention and to create personalized care pathways and medical treatment, including drugs, immunotherapy, DNA modification, based upon personal genetics and medical histories. Because of the standardization of communication regarding the patient's care and treatment, the patient can be assured that at all times, all relevant information is maintained and can be accessed using satellite, wireless communication instruments on a world-wide basis as needed.

Not only is the information maintained on a standardized basis, if a patient needs to access information out of the country, there is a common language and code so that foreign physicians or providers know how to access/understand and treat the patient. The patient's care and treatment will be incorporated as a standardized international language.

Based upon the Internet health care system, patients can readily access and utilize the system from any place in the world, and health care providers can be integrated into the system and use the automated standards of care, care pathways and protocols on a worldwide basis. Accordingly, patients traveling abroad can maintain ongoing connections with their community treating physicians and providers regarding health care matters, access their own personal medical records, and document any health care episode in a standardized fashion in their records. For example, but not by way of limitation, global standardization offers great potential for U.S. military families and other non-military personnel living abroad. It also offers under-developed countries to access U.S. standard of health care, and can import standards of care, critical pathways and protocols, and new healthcare items and services from other countries or regions.

The preferred embodiment of the present invention can include networks of providers in other countries. Initially, foreign providers could provide care and treatment to U.S. enrollees. The preferred embodiment of the present invention would advise foreign providers not only of pertinent patient health care information, but would also give them access to the standards of care and protocols regarding care and treatment of the U.S. enrollees. When the present invention is used outside the U.S., it can create networks of providers linked via the Internet into a global Internet health care delivery system. As a result, health care treatment and management knowledge extent outside the U.S. can be incorporated into the Internet health care delivery system. In addition, the ability to collect and collate standardized data will permit creation of integrated databases for research, clinical research, post-market surveillance, documentation and utility and costs of other health care treatment modalities.

The globally standardized internet health care delivery system would become the gateway or distribution network for the implementation of new healthcare products, devices, procedures, services, care pathways, applications and technologies. For example, but not by way of limitation, if a new technology is developed to monitor and/or treat a chronic health condition, the present invention can incorporate that technology in a standardized fashion and, via the Internet, educate patients and treatment providers regarding its availability and applications. In addition, because of the integration with the health care finance mechanism, the present invention can facilitate the design of the optimal health care finance mechanism to integrate the new technology or healthcare offering in the most cost efficient manner.

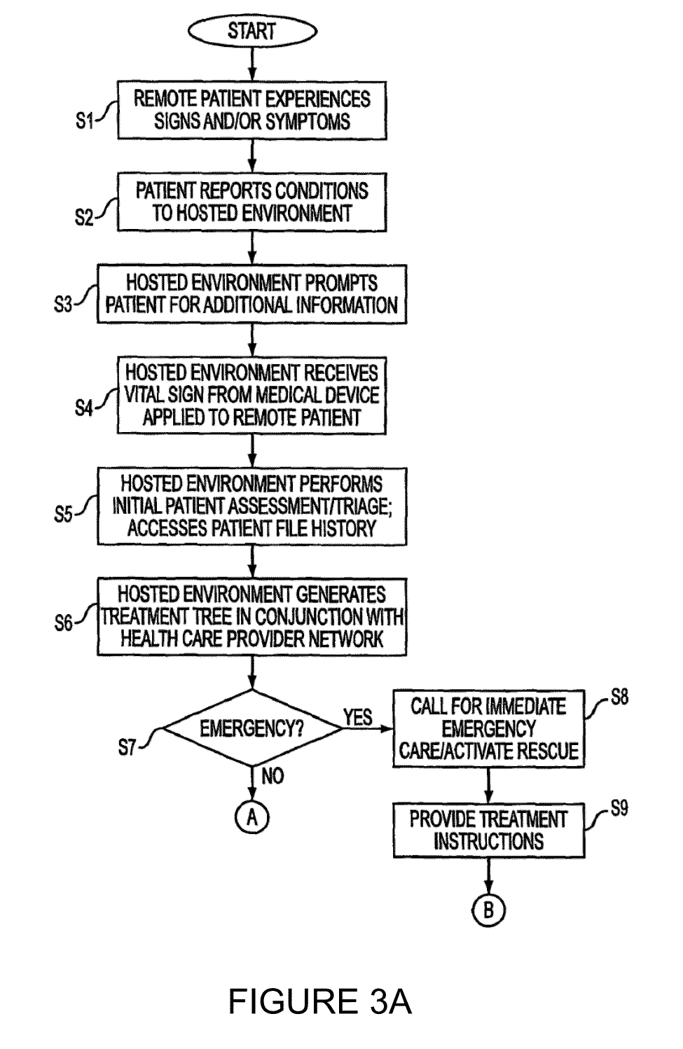

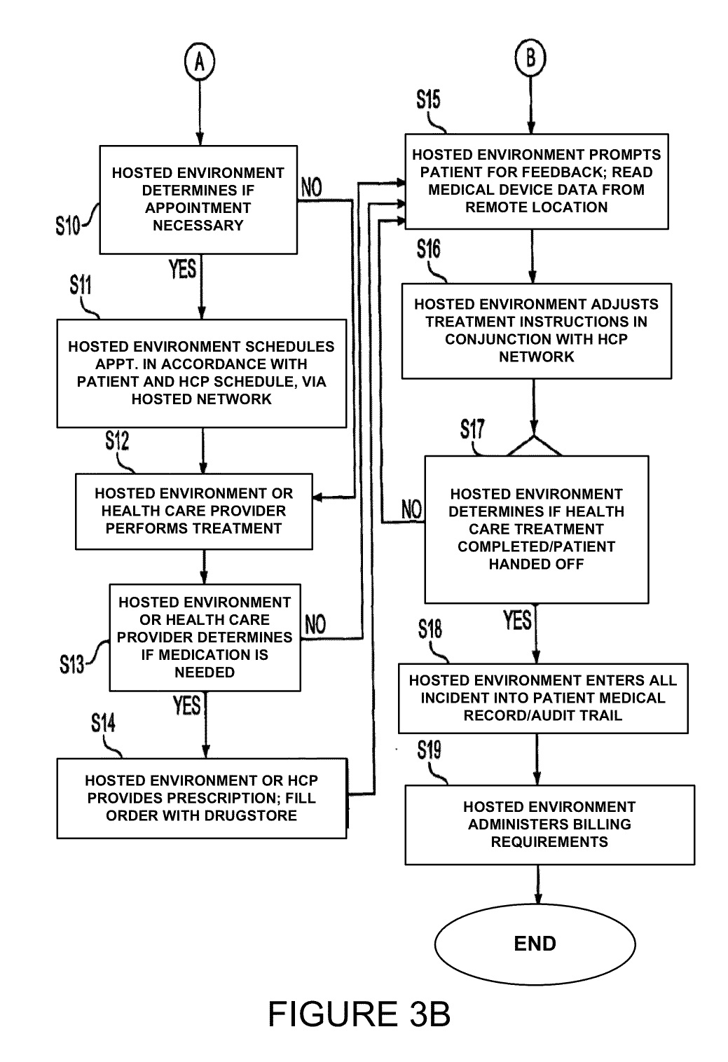

FIGS. 3a and 3b illustrate a preferred method of operating the preferred embodiment of the present invention. In a first step S1, the remote patient (i.e., substantially not in the presence of a health care provider or facility) experience signs and/or symptoms indicative of a need for medical treatment. The signs and symptoms may include, but are not limited to, fever, nausea, high blood pressure, pallor, dilated pupils, nature of an injury, chest pain, difficulty breathing, and a change in or need to check a chronic disease condition, such as glucose levels, blood oxygenation, or the like. Alternatively, the system may prompt the patient to check a condition.

In a second step S2, the patient reports the aforementioned conditions to the hosted environment (i.e., sponsor network). The communication can be via land line or wireless communication, and may include a global positioning system (GPS) to determine location, especially if a hand-held communication device is used in the field. The reporting can take place via a computer, wireless pad, telephone, or other communication device linked via a network (e.g., Internet, Extranet or private network).

In a third step S3, the hosted environment prompts the patient for additional information in order to make a more accurate diagnosis or assessment. In the next step S4, the hosted environment may also request the attachment of a medical device or prompt the patient to download a mobile application to be used by the patient to obtain more detailed information on vital signs and/or symptoms. For example, but not by way of limitation, the hosted service may instruct the patient to wear a sphygmomanometer (i.e., blood pressure monitoring device), use a hand held device such as a scanner or ear scope or a mobile app or home testing device or kit.

After receiving the inputs regarding the patient signs and/or symptoms, in step S5, the hosted environment automatically accesses and assesses the patient's medical history and the data, and performs initial patient assessment (e.g., triage, diagnosis, need for medical services, chronic disease condition), based upon the hosted protocols, pre-standing orders, care pathways and/or standards of care. In the next step S6, the hosted environment automatically generates a diagnosis or treatment tree or healthcare instruction, including at least one diagnosis, treatment, instruction or assessment parameter. The treatment tree or healthcare instruction may be generated in conjunction with the health care provider network. Alternatively, because the provider network has licensed and pre-approved the hosted environment to perform the diagnosis, treatment or issue the healthcare instruction or assessment, the hosted environment may perform the healthcare service directly to the patient, without immediate review and authorization by the physician or health care provider, depending on the preference of the health care provider and/or patient.

Then, in the seventh step S7, the hosted environment determines whether the present medical condition of the patient constitutes an emergency. If so, then the Emergency Medical Services (EMS) network is activated by calling for immediate emergency care (i.e., dial 911) in the next step S8, and then in a following step S9, the patient is provided with emergency treatment instructions, to be performed while waiting for emergency care to arrive.

If there is no emergency, then it is determined whether an appointment is necessary. That determination may be made by the patient, hosted environment, and/or health care provider. If an appointment is required, at step S11 the hosted network automatically schedules an appointment in accordance with the health care provider schedule and patient's preference. If the patient's primary health care provider is not available, the patient will be given a series of backup options, all conforming to the same level of standardization as the patient's primary health care provider. If no appointment is required, then step S11 is skipped.

Next, at step S12, treatment is performed or health instruction is implemented. The treatment may be automated, remote, using the above-described medical devices to perform remote surgery, administration of medicine or a treatment device or the like, a change in medication or the like or the treatment may be in-person or via a remote camera if an appointment was scheduled. The system monitors the administration of the treatment and captures the data regarding the treatment. After treatment has been performed, step S13 determines whether follow up care such as medication is needed. If so, the system may automatically fills the prescription in step S14 and if desired by the patient, arranges the delivery or pick-up options with a local medicine retailer (e.g., pharmacy).

After completing steps S13 and S14, or alternatively, step S9, step S15 is performed. At step S15, the hosted environment prompts the patient for feedback, and the patient transmits a feedback signal or message to the hosted environment. The feedback signal or message can include, but is not limited to, a reading of any medical devices attached to the patient, data transmitted by a medical device, descriptions of patient condition, or reports on results of treatments administered. The feedback may also include a report from EMS personnel that the patient is in their care. Then, in step S16, the hosted system either automatically or in accordance with the health care provider network adjusts the healthcare instructions or treatment based on the feedback from step S15.

At step S17, the hosted system determines whether health care treatment has been completed, or if the patient has been “handed off” to another health care system (e.g., EMS feedback for emergency patients). If not, steps S15-S17 are repeated until the answer is “YES”. If so, then all incident information is entered into the computable data base and the patient's electronic medical history, so as to append the audit trail and the patient's medical record for more accurate future treatment, at step S18. Step S18 is standardized. In step S19, the system automatically administers the billing and reimbursement requirements (e.g., insurance payment) to complete the online process.

In a first example of the preferred method illustrated in FIGS. 3a and 3b, a patient logs onto their personalized website using the patients' personal code with allergy symptoms. The patient provides the necessary information through screens that incorporate the standard of practice and protocols related to allergies to the sponsor network. The information provided by the patient is correlated with the patient's medical record and history for past episodes, drug reactions, and the like. In accordance with nationally recognized standards of practice, care pathways and protocols, the system offers the patient treatment options (e.g., over the counter or prescription treatment options) along with the costs to the patient based upon the patient's pre-established personalized health care finance system (e.g., prescription drug co-payment or generic options). The patient selects the treatment preferred (e.g., a prescription drug). The system automatically authorizes the prescription based upon the patient's history and the hosted standards of care, care pathways and protocols, and routes the communication to the patient's designated pharmacy and provides a report to the treating physician or provider (e.g., treating network). The report may include any supporting information (e.g., pollen count or abstract or recent article, drug therapeutic information).

The system automatically electronically transmits the prescription to the participating pharmacy designated by the patient. The pharmacy delivers the drug by mail or otherwise to the patient. The patient receives confirmation that the drug has been ordered, the expected time of delivery, and the patient's insurance claim is administered or account is debited or credit card is charged, as applicable. This interaction becomes a part of the patient's medical record. If the system determines that it cannot automatically authorize the prescription based upon the data provided by the patient and/or the patient's history or the standards of practice, critical pathways and protocols, the system automatically transmits the patient's healthcare request and relevant data to the patient's provider. The patient's provider may then authorize the prescription and the system fills the prescription and records the data as set forth above. Alternatively, the provider can initiate different actions using the system or otherwise intervene with the patient via email, telephone, or an appointment (which the system is prompted to schedule).

The system provides the patient ongoing support to help the patient manage the allergies, such as pollen count, environmental assessments and drug therapeutic information. The system tracks the patient's compliance with the drug therapy and therapeutic results. If the patient does not obtain adequate relief the system will assess the patient's personal health information and lack of adequate relief against critical pathways and recommend additional treatment options such as allergy shots. If the critical pathway requires additional information or a physician consultation in order for the patient to access allergy shots, the system will provide or direct the patient to obtain or provide the additional information and or will automatically arrange the physician consultation, including via the internet.

In another example of the preferred method illustrated in FIGS. 3a and 3b, a patient accesses the system in the middle of the night to report crying baby with a temperature of about 102 degrees Fahrenheit. The system advises the patient that the most likely diagnosis is an ear infection and prompts the patient to download a mobile application onto the patient's mobile phone that will take a picture of the baby's ear and transmit it to the system. The system or the app will verify the diagnosis as an ear infection. The system will provide treatment instructions to the patient. If the treatment includes a prescription drug, the system will automatically notify the pharmacy and the prescription is provided as described above. The system automatically follows the baby by prompting the patient for reports regarding the baby's condition and provides ongoing instructions until the patient reports the baby's condition is normal. If the condition worsens or the diagnosis of an ear infection is not confirmed, the patient is advised regarding symptom management and of things to watch for if conditions worsen. The system schedules an appointment with child's pediatrician during early morning sick child appointments and patient is notified that the appointment is confirmed. Throughout the episode, the system is available to interact with patient as needed. The interaction becomes part of the patient's medical record.

In another example of the preferred method illustrated in FIGS. 3a and 3b, a patient suffering from chronic heart failure transmits daily weight and vital signs to the system. Based upon the data, the system determines that the patient requires a medication adjustment, such as taking Lasix, the system instructs the patient and monitors for compliance with the instruction. The system also reminds the patient of the importance of a proper diet, and similar steps. The system continues to monitor the patient. If the patient's condition worsens, the system will prompt the patient of the need for an office visit and will make the appointment as described above. The data and encounter are entered into the patient's electronic medical record. The system monitors the patient and provides periodic reports to the patient's provider as specified by the provider.

Further, the system can prompt the mother to download a mobile application that can remotely diagnose an ear infection or to order a scope with a camera to check the child's ear for an ear infection from the all-night pharmacy. The mother enters symptoms into system and either puts scope in child's ear and transits picture along with symptoms or uses the mobile application hosted by the sponsor network. The sponsor network correlates information, confirms that the condition is an ear infection, and orders antibiotic for delivery to home. The mother is advised of those developments. The entire process is done automatically via the internet, and incorporated into the patient's medical record. The treating physician is also automatically advised, and can intervene if desired. The mother may receive automated e-mail reminders regarding follow up (e.g., reminders to take all of medicine as prescribed, related information, dangers of not taking all of medicine). If condition worsens, the mother is advised that a physician visit is needed and appointment is scheduled electronically.

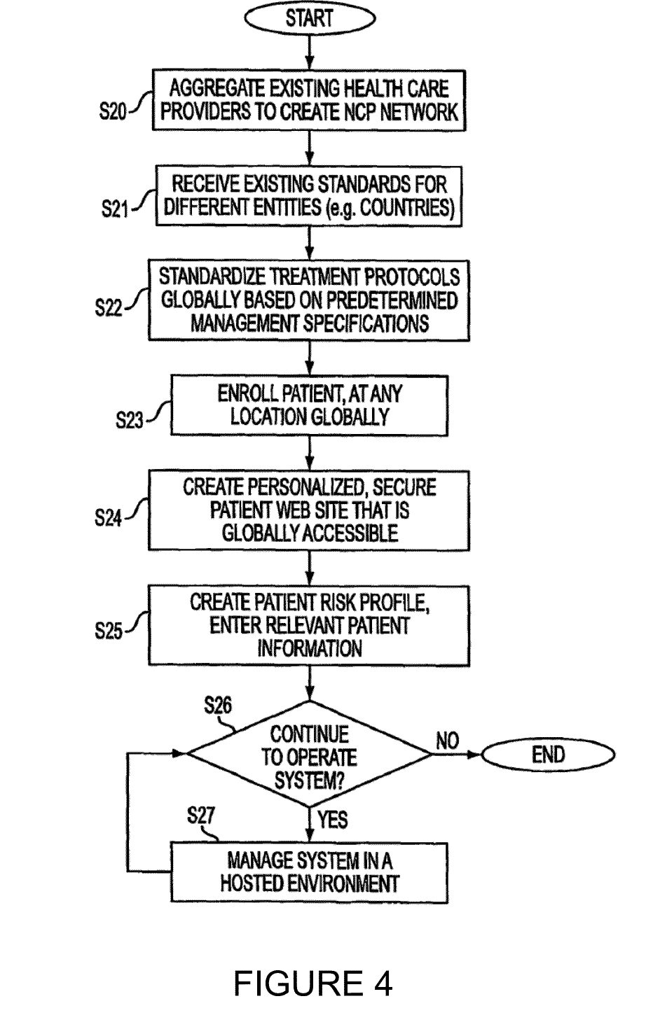

FIG. 4 illustrates a method of designing and developing the hosted environment according to the preferred embodiment of the present invention. In a first step S20, existing health care providers, which are independent and disaggregated in the prior art system, are aggregated into a large-scale health care provider network. In step S21, the standards for different systems and countries are received, and at step S22, treatment procedures are standardized globally, based on predetermined management specifications. The global healthcare services standardization includes, but is not limited to, diagnosis, management, health care access, and treatment protocols. Step S21 includes populating the hosted environment with the necessary data.

After step S22 has been completed, the system is operational, and a patient can be enrolled at any global location, as is done in step S23, which may be accomplished by wireless or land line communication of any type. At step S24, a personalized secure patient interface is created (e.g., web site), such that patient can access the web site from any location in the world. Further, at step S26, it is determined whether to continue to operate the system. If so, the system is managed in the hosted environment in step S20, for use in accordance with FIGS. 3a and 3b.

In an example according to the preferred method illustrated in FIG. 4, a payor determines that it will fund online prescribing and internet disease management programs. The sponsor network develops the specifications for the disease management program and online prescribing infrastructure and providers and solicits bids. The sponsor network then negotiates and enters into contracts with the program sources and manages contract operations, and establishes reimbursement levels to the relevant treating physicians or providers (e.g., primary care, pulmonologists, and the like), and configures and communicates with the participating provider network about the programs and reimbursement procedures. Next, the sponsor network enrolls the patients and incorporates the online prescribing and disease management protocols, standards of practice, devices, mobile applications, electronic patient surveys, and other related components into the hosted Internet delivery system.

The sponsor network also automatically administers the payments from the payor to the physicians and other participants, and maintains the electronic medical record of all internet interactions for each patient and provides reports, conducts oversight and other activities that are part of the overall program. The system, providers or a payor may determine that it desires to provide patients with incentives to participate in these programs. Further, the sponsor network administers the patient incentive program. For example, but not by way of limitation, the patient earns points for using the system and activities that support the programs (e.g., tracking diet, attacks, use of medications), and can earn rewards for the participation. The system automatically documents compliance and tracks the patient's rewards and administers the incentive award program.

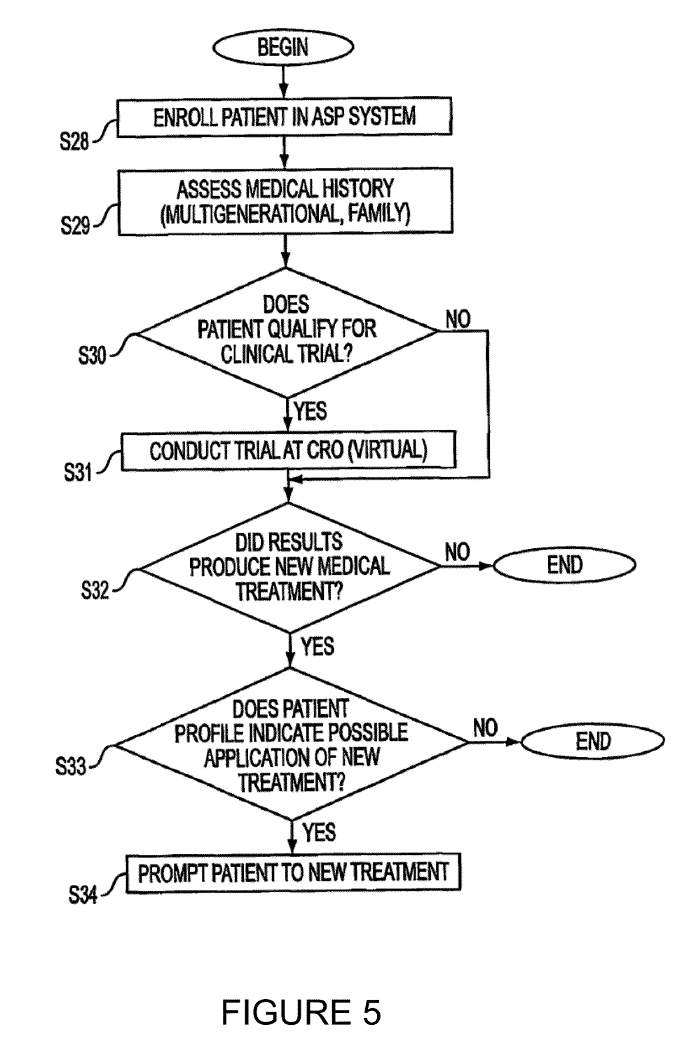

FIG. 5 illustrates a method of creating a virtual clinical research organization (CRO) according to the preferred embodiment of the present invention. The components and networks of the system enable conduction of formation of online automated research (i.e. retrospective analysis), clinical research, and post-market surveillance. According to the preferred embodiment of the present invention, the system hosts the research or surveillance protocol, automatically identifies eligible patients, obtains any necessary consents from identified patients, identifies physicians and other providers to participate in the research, obtains any necessary agreements to participate in the clinical research or post-market surveillance and enrolls providers and patients in the clinical trial or post-market surveillance. The components and networks of the system automatically tracks and captures healthcare data, including all health care services provided to the patient, the patient's compliance with the therapy, the patient's response to the therapy, including quality of life measures, the presence or absence of other factors, such as smoking, alcohol use, diet, exercise, environmental factors, and other data points, on a 24-hour, 7 days-a-week basis for each enrolled patient and provider. The data is collected in compliance with hosted protocols into computable databases and the system conducts data analytics and issues reports in compliance with hosted protocols. The system also may create specialty networks and product research. In step S28, the patient is enrolled in the above-described health system according to the preferred embodiment of the present invention, as illustrated in FIG. 2. Then, in step S29, multigenerational family history is assessed from the patient and family history and the patient's and medical record, such that genetic information of previous generations on various conditions (e.g., heart disease, high blood pressure) is readily accessible to permitted users, and the system automatically screens the database of enrollees to identify qualified potential candidates for the research, clinical trial or post market surveillance.

Next, at step S30, the system determines whether the patient qualifies for participation in a clinical trial, research or post market surveillance. This determination can be based on the hosted patient history and medical records as well as current diagnoses and/or treatments being administered to the patient. For example, but not by way of limitation, if the patient is experiencing depression, and there is a clinical trial for depression patients, the system will automatically notify patients of their potential eligibility for the clinical trial and their treating physicians, and may invite the patient and treating physicians to participate in the clinical trial. If the patient and, if needed, the treating physician, accept the invitation and consent to participation in the trial, research, or post-market surveillance, the system automatically consents and enrolls the patient in the research, clinical trial or post market surveillance at Step S30. The research/surveillance is conducted by the system/virtual CRO at step S31, in accordance with the hosted protocol(s), utilizing all of the relevant networks, hosted care pathways, standards of practice and protocols and data capture and analytics in the preferred embodiment of the present invention. Accordingly, the CRO includes a patient profile comprising a history and multigenerational family history in a said health care network, an automated identifier that determines whether said patient is a candidate for research or surveillance, and an enrollment management and data collection and reporting system in a networked, hosted environment. Said research/surveillance is documented in a globally accessible database having a standardized protocol.

Under current research or surveillance programs, data is only captured from patient/provider encounters, and the program rely on patients to self-report results. Providers must re-enter data into the research database and patients must be separately contacted to collect outcomes or other relevant data if such data is not collected by providers participating in the study or registry. Patients must be identified and consented in person by providers participating in the study or registry. Reporting of adverse events depends upon the individual judgment of providers participating in the study. Safety and efficacy data is collected, but little or no quality of life data is collected. Only limited post-market surveillance of patients receiving approved therapies can be conducted.

Under several embodiments of the present invention, the system automatically collects and correlates data regarding the patient's receipt of all medical services and encounters with providers participating in the system (including those such as primary care physicians or mini-clinics that are not participating in the research or surveillance registry), the patient's compliance with and response to the treatment and other factors, adverse events, genetic information, and family history in accordance with the hosted protocols. All patients enrolled in the system that receive an approved specific test, drug or device therapy can be followed under post-market surveillance protocols and long outcomes can be tracked on a longitudinal basis. The system also collects all data generated by operation on the system into a computable database that can be used for retrospective research and predictive analytics.

Regardless of whether the patient participates in the clinical trial or the registry, it is determined by the research conducted by the system in step S32 whether the clinical trial has produced a new medical diagnostic or treatment. If so, then in step S33, the hosted environment can automatically determine which patients enrolled in the system would potentially benefit from the new medical diagnostic or treatments based on their histories and electronic medical records and the new medical diagnostic or treatment indications and study results. If the patient qualifies, the system can identify the treating physicians and advise the physicians of the new medical diagnostic or treatment. If the treating physician authorizes the diagnostic or treatment, then the patient is offered participation in the new diagnostic or treatment at step S34. The prompting may take place automatically via the hosted environment or the treating health care provider. Accordingly, the system determines the results of said clinical research, compares said clinical research results to the patient profile to generate a comparison result, and prompts the patient and/or the patient's provider to apply said clinical research results to treatment instructions for said patient, particularly wherein said clinical research result comprise a previously unavailable medical diagnostic treatment.

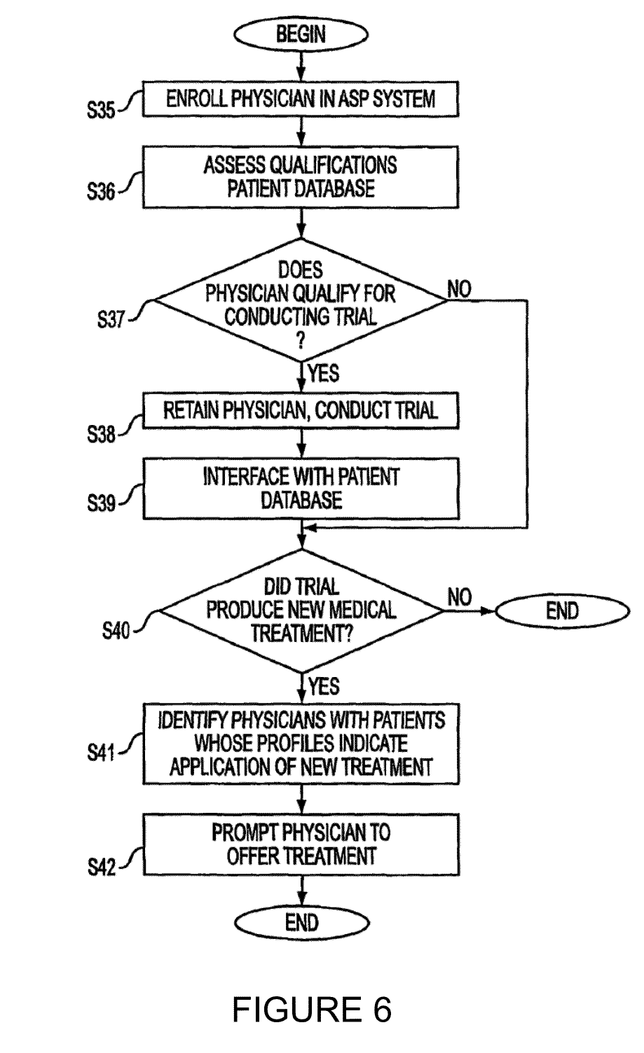

As illustrated in FIG. 6, the virtual CRO concept also applies to the physician. In a first step S35, the physician is enrolled in the ASP system (i.e., hosted environment). Then, at step S36, the qualifications of the physician and their patient database are assessed. In a next step S37, it is determined whether the physician qualifies for conducting a trial or participating in a post-market surveillance registry. If so, step S38 is conducted, wherein the physician is invited to participate, and upon acceptance of the invitations, is retained and the trial is conducted, followed by step S39, during which the ASP interfaces with the patient database.

If the physician does not qualify at step S37, or alternatively, after step S39 is completed for a qualifying physician, it is determined whether the trial produced a new medical diagnostic or treatment at step S40. If so, then at step S41, the ASP identifies physicians having patients with profiles that are indicative of qualifying for application of the new diagnostic or treatment. Next, at step S42, the physician is prompted to offer the treatment to the patient. The system can also identify physicians with specialties that would be qualified to provide the new diagnostic or treatment to patients and alert them to the availability of the new diagnostic or treatment modality. The system can also provide information, study results and simulated training on the new diagnostic or treatment modality. Because the system can conduct automated post-market surveillance of a specific diagnostic or treatment modality, barriers to regulatory approvals for new products and new indications, applications are alleviated. The system's collection of outcomes and cost effectiveness data also supports efficient coverage and reimbursement decisions as well as increasing patient awareness of and access to new diagnostic and treatment modalities. In addition, because patients, providers and payors are enrolled and integrated by the system, new reimbursement methodologies can be utilized and tracked. These include risk-based methodologies, such as capitation, bundled payments, pay for performance methodologies. As another example, implantable device therapies, currently reimbursed under the payment for the implanting procedure, could instead be reimbursed on a monthly subscription basis.

The present invention uses the Internet to integrate together the community of treating physicians and providers, to integrate this network of treating physicians and providers with their own patients, and to interface this community of Internet-based treating physicians and their patients with the Internet health content and business-to-business companies. In completing this integration, it becomes possible to use the Internet in actually delivering health care services. One of the current limitations to this application is that treating physicians are currently primarily compensated only for face-to-face patient care, so that they have little reason to consider different ways of taking care of patients. In addition, as a result of the current reimbursement system, there is managing the continuum of care for patients and utilizing population health management protocols. Currently, consumers are required to navigate the health care system on their own but are not empowered to do so, and these difficulties are combined with the reality that, on their own, clinical decisions are largely driven by the reimbursement system. Again, however, the current health Internet initiatives are merely pre-set formats with a lot of general information. Consumers can spend hours on the Internet trying to sift through various health care sites to get meaningful information that applies to his or her own situation, but their own treating providers or caregivers are not in the loop and the health insurer is generally viewed as an adversary. Further hampering the situation are other factors: health care systems are financially strapped and are not pursing new initiatives; e-content and commerce companies lack a national sales force to reach the fragmented physician community; physicians lack the time or resources to incorporate Internet communication at the doctor's office, and, without compensation, have little incentive to do so.

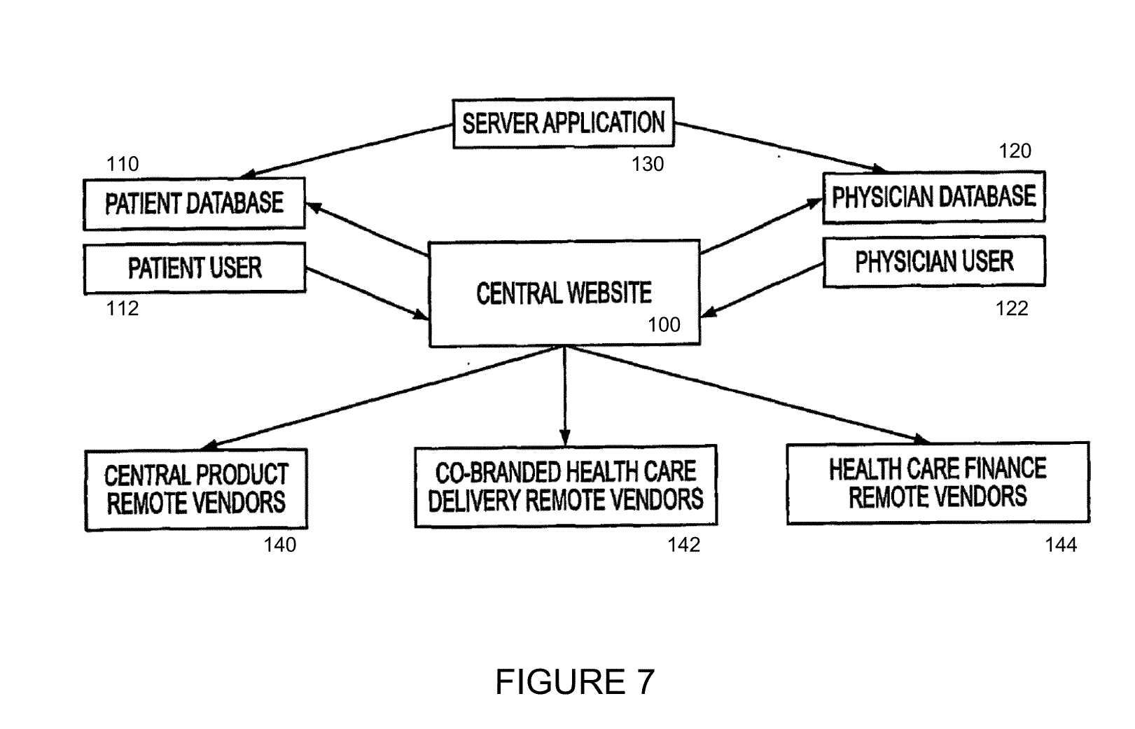

FIG. 7 illustrates an overview of the system architecture according to a preferred embodiment of the present invention. A central website is coupled to a patient database and a physician database, such that the patient and physician can communicate with one another via the central website. Further, a server application links the physician database with the patient database. Additionally, the central website is coupled to central product remote vendors, co-branded health care delivery remote vendors and health care finance remote vendors.

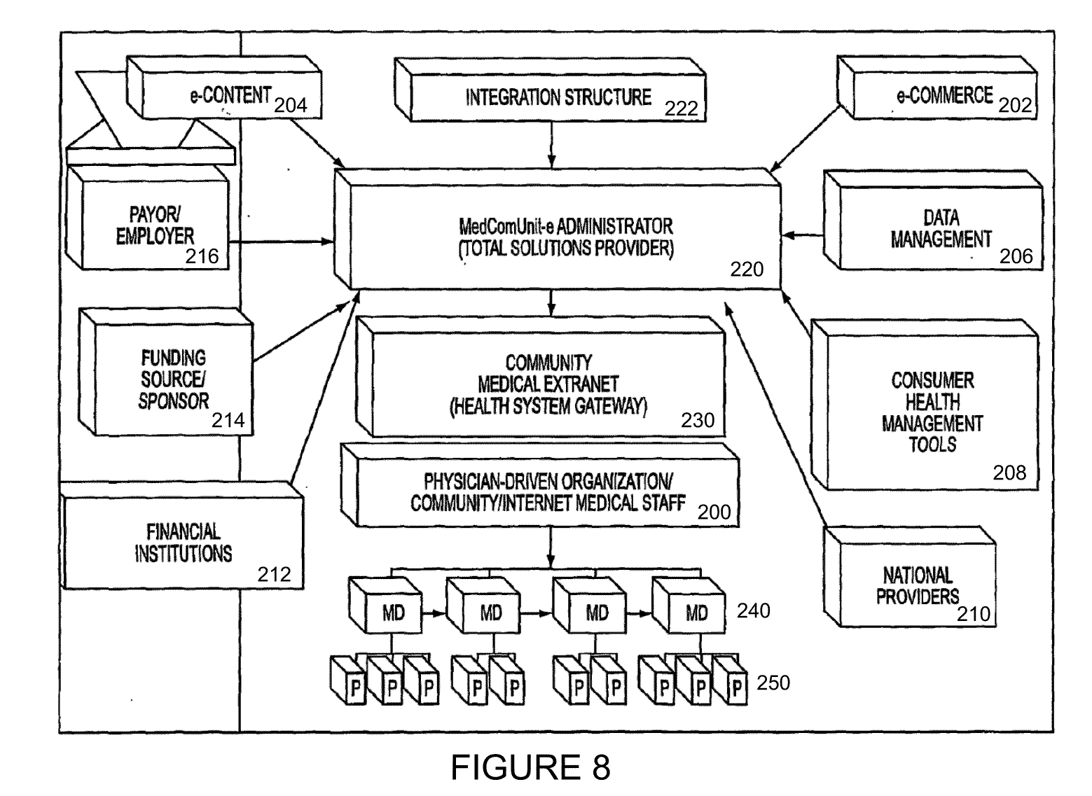

FIG. 8 illustrates the physician-driven organization, which is described below in greater detail and is an alternative preferred embodiment of the present invention. A total solutions provider (TSP) receives inputs from e-commerce and/or e-content sites, data management, consumer health management tools, national providers, financial institutions, funding sources and/or sponsors, payors and/or employers, and an integration structure site. The TSP generates an output to a Community Medical Extranet (i.e., health system gateway), which interfaces with a physician-driven organization (PDO). The PDO includes community and/or internet medical staff, and is linked to health care providers (e.g., physicians), who are in turn linked to patients.

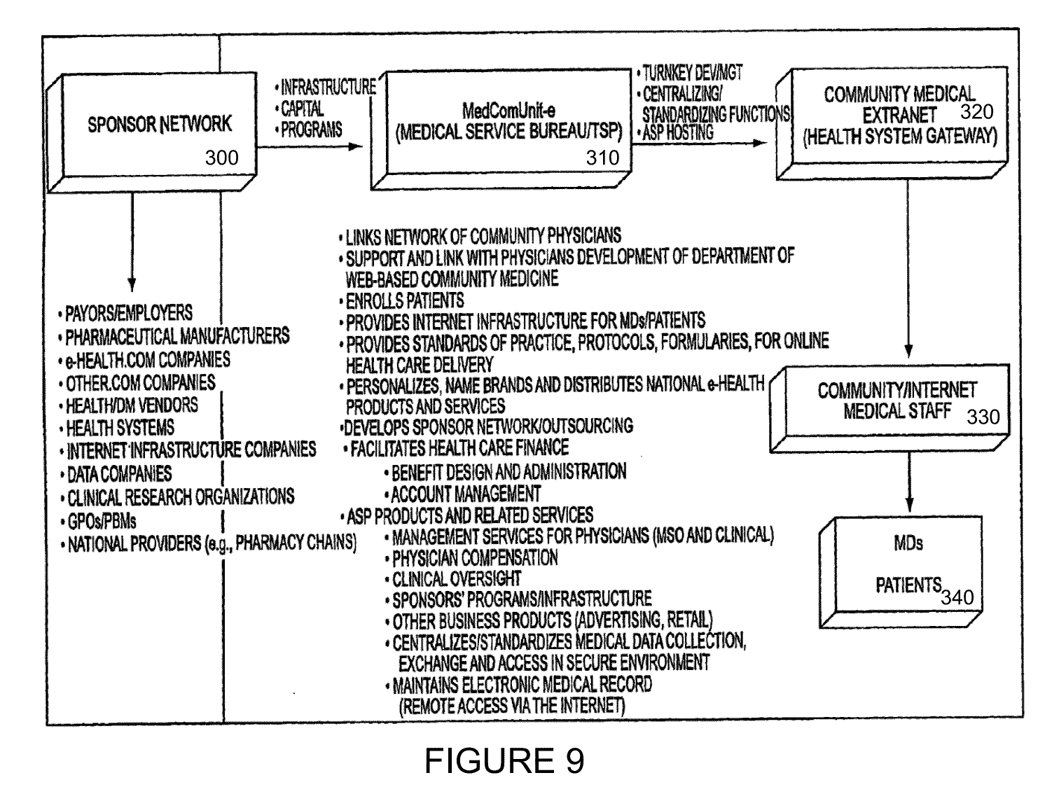

FIG. 9 illustrates an alternative preferred embodiment of the present invention. The sponsor network includes payors/employers, pharmaceutical manufacturers, online health companies and other online companies, health vendors and health systems, intranet infrastructure companies, mobile applications, hand-held devices, CRO's and national providers. The hosted environment links the network of community physicians, as well as supporting and linking with physicians development of department of web-based community medicine. Further, the hosted environment enrolls patients, provides an internet infrastructure, standardizes online health care delivery, and personalizes and brands national health products and services. Also, the hosted environment facilitates health care finance, and provides ASP products and related services, including, but not limited to, compensation for health care providers, clinical oversight, and maintenance of electronic medical histories.

The hosted environment is coupled to the Community Medical Extranet, which is coupled in turn to the community/internet medical staff, which is in turn coupled to the physicians and patients.

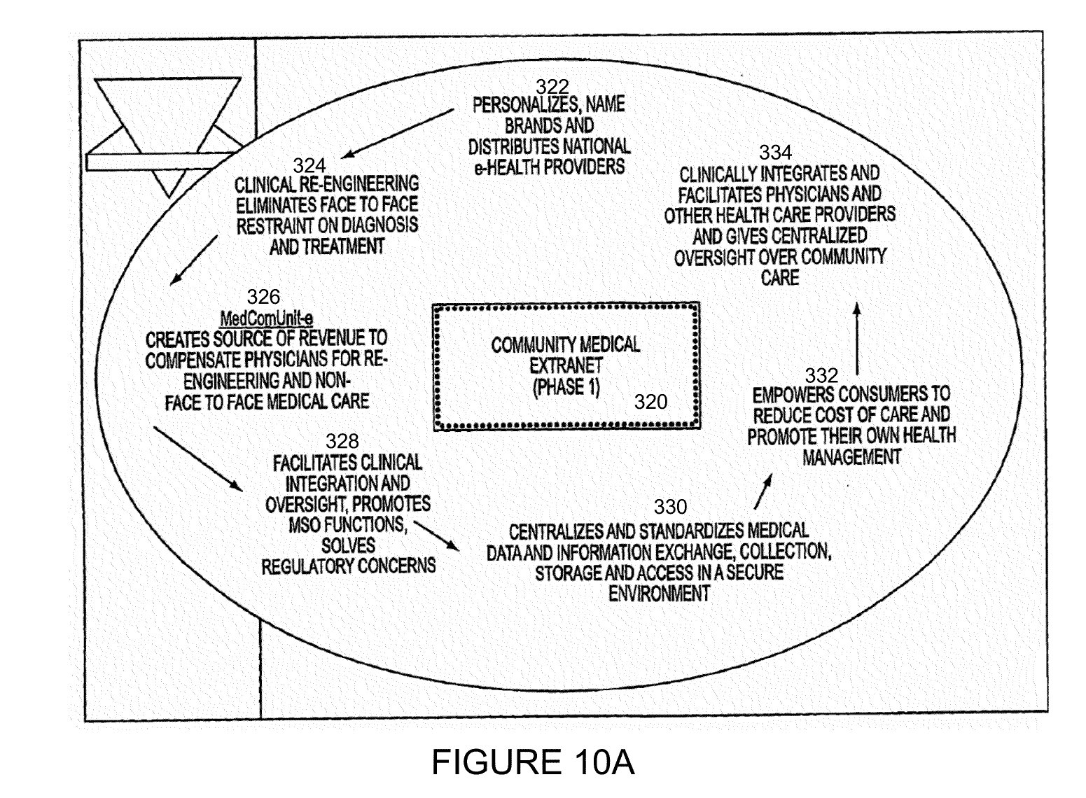

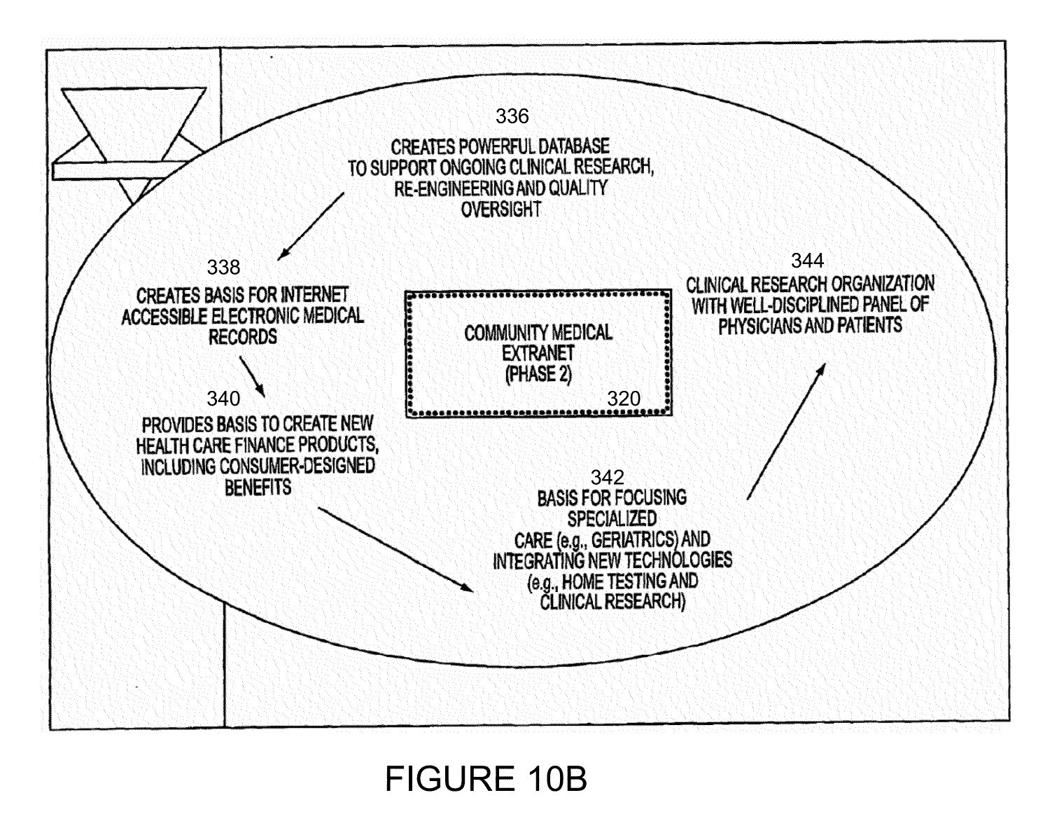

FIGS. 10a and 10b describe the necessary steps in phase 1 and phase 2 of the Community Medical Extranet, respectively. In FIG. 10a, phase 1 begins with personalizing, branding and distributing national e-health providers, followed by clinical re-engineering to eliminate face-to-face restraint on diagnosis and treatment. Then, the hosted environment creates a source of revenue to compensate health care providers for remote treatment and re-engineering, followed by facilitating clinical integration and oversight (including regulatory concerns). Next, medical data is standardized and centralized, as well as collected and stored in a secure environment, which is in turn followed by empowering consumers to reduce the cost of care and promote their own health management. At the end of phase 1, the hosted environment clinically integrates and facilitates physicians and other health care providers and provides oversight for community care.

In phase 2, as illustrated in FIG. 10b, a database is created to support ongoing clinical research and quality control, followed by creating the basis for internet accessible electronic medical records. Then, a basis is provided to create new health care finance products (e.g., consumer-designed benefits), and that step is followed by a basis for focusing specialized care and integrating new technologies. Finally, phase is completed with the step of a CRO with a well-disciplined panel of physicians and patients.

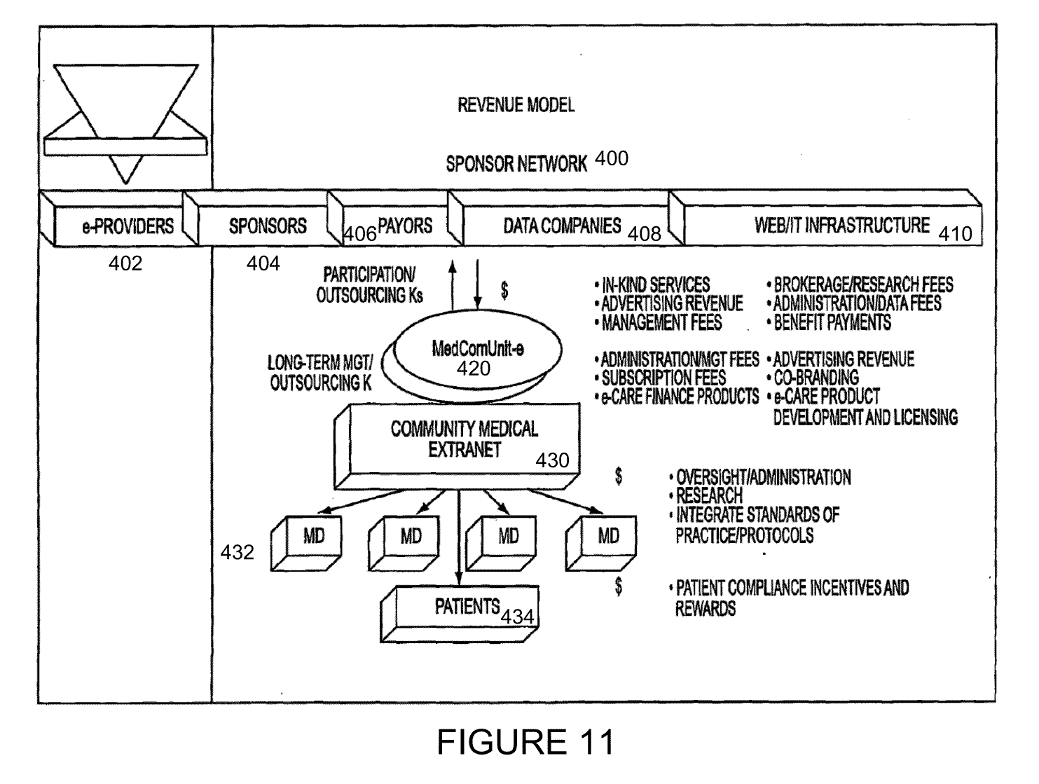

FIG. 11 illustrates a revenue model according to the preferred embodiment of the present invention, which is described in greater detail below. A hosted environment includes a sponsor network that includes e-providers, sponsors, payors, data companies, and includes the web and information technology infrastructure. The hosted network interfaces with the Community Medical Extranet, which interfaces with physicians and patients. The revenue model provides patient compliance incentives and rewards, as well as financial incentives to physicians for oversight/administration, research, and integration of standards of practice and protocols. The hosted environment revenue includes sales of products, advertising revenue, co-branding, subscription fees, and product licensing. The revenue model further includes in-kind services, advertising revenue, management fees, brokerage/research fees, benefits payments and administration/data fees.

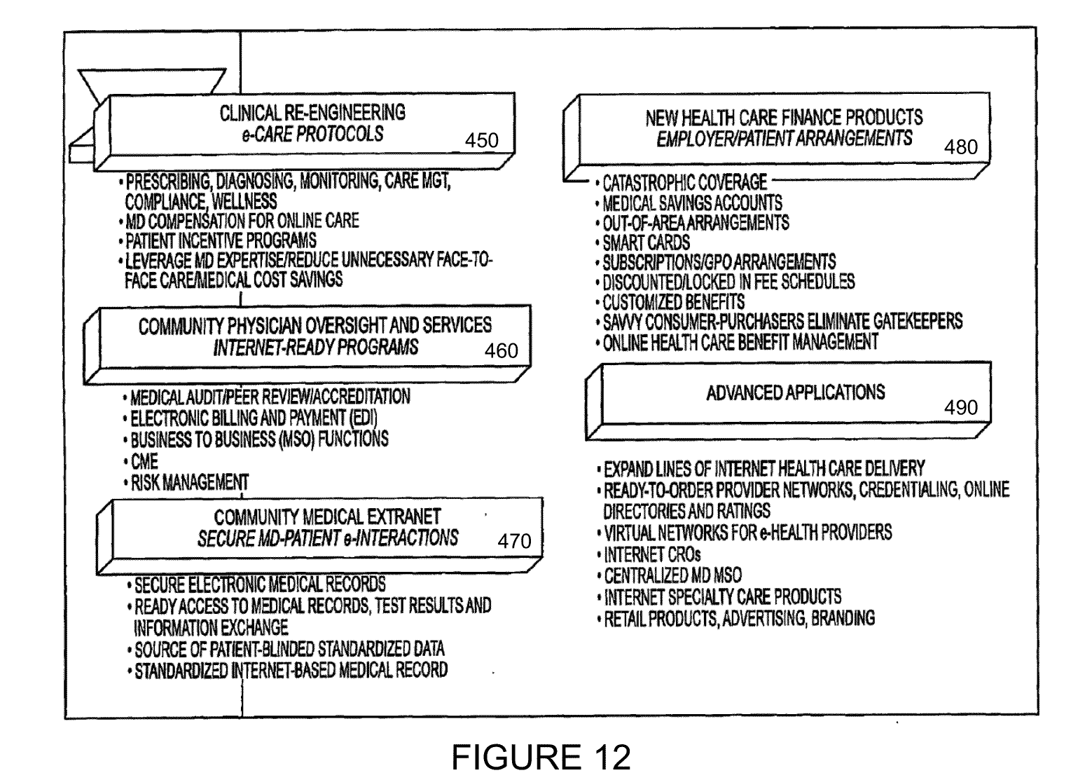

FIG. 12 illustrates various types of functions performed by various preferred embodiments of the present invention. The main categories include clinical re-engineering, community physician oversight and services, Community Medical Extranet, new health care finance products, and advanced applications.

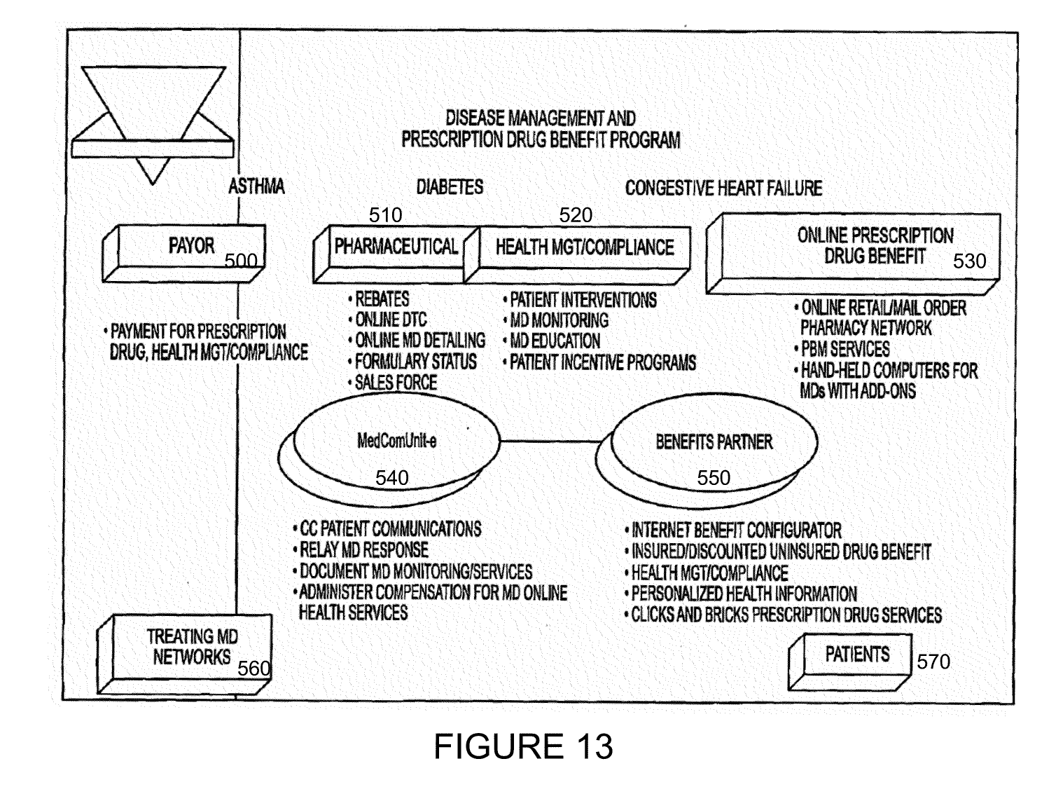

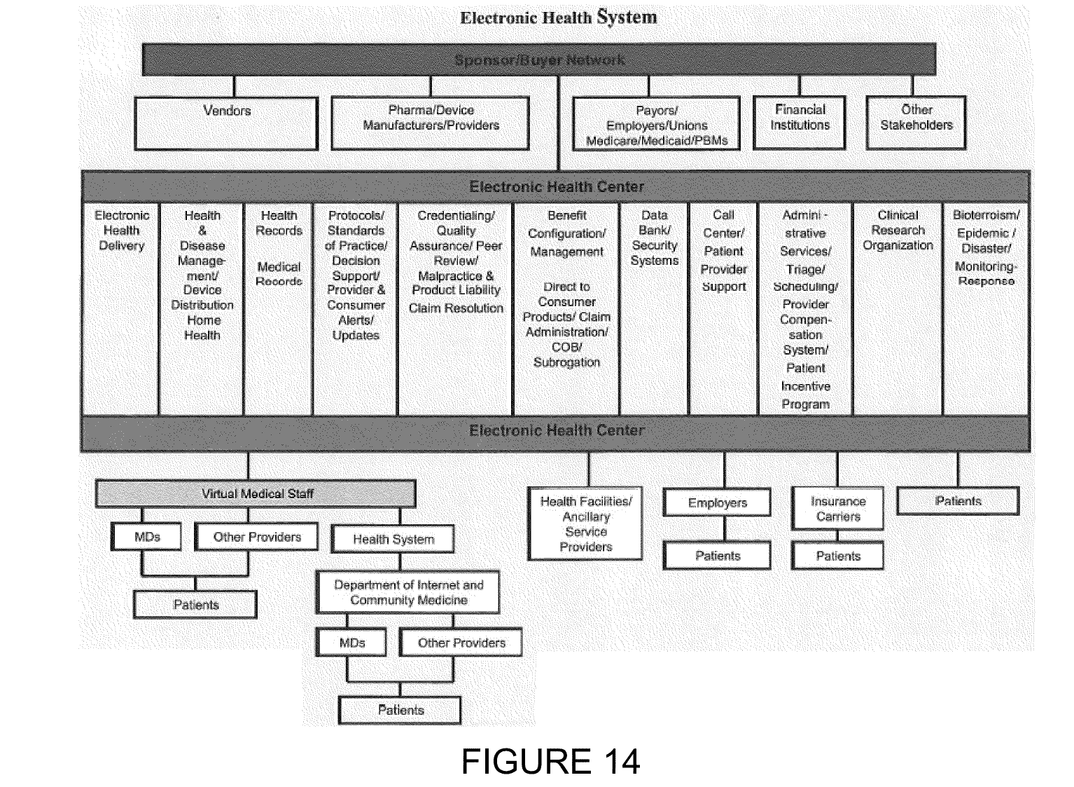

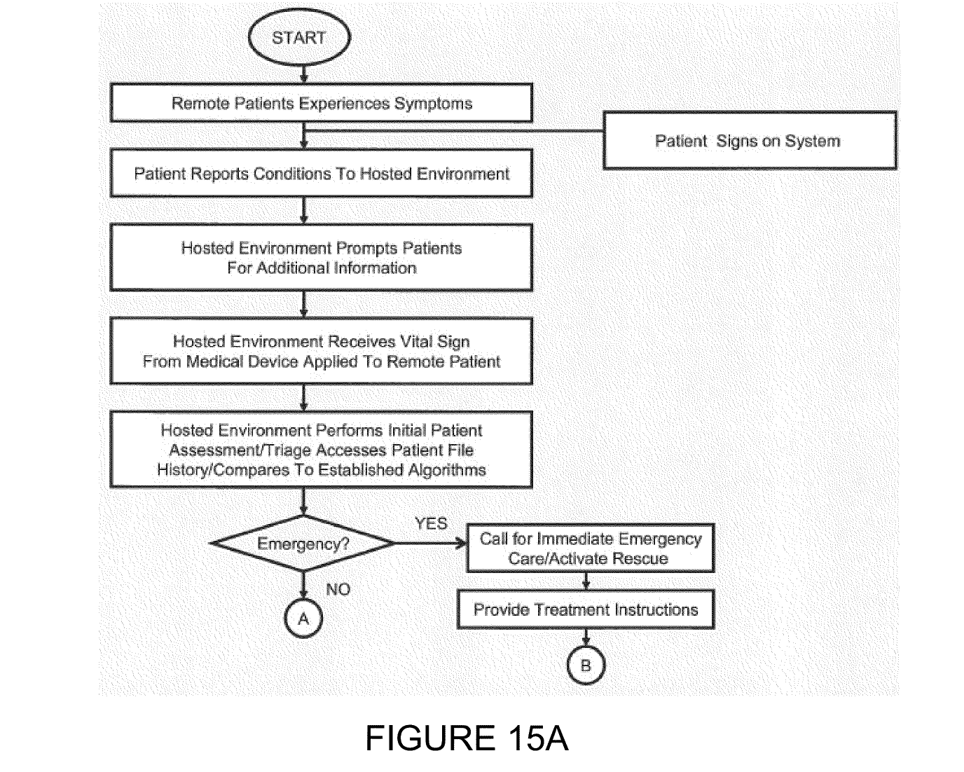

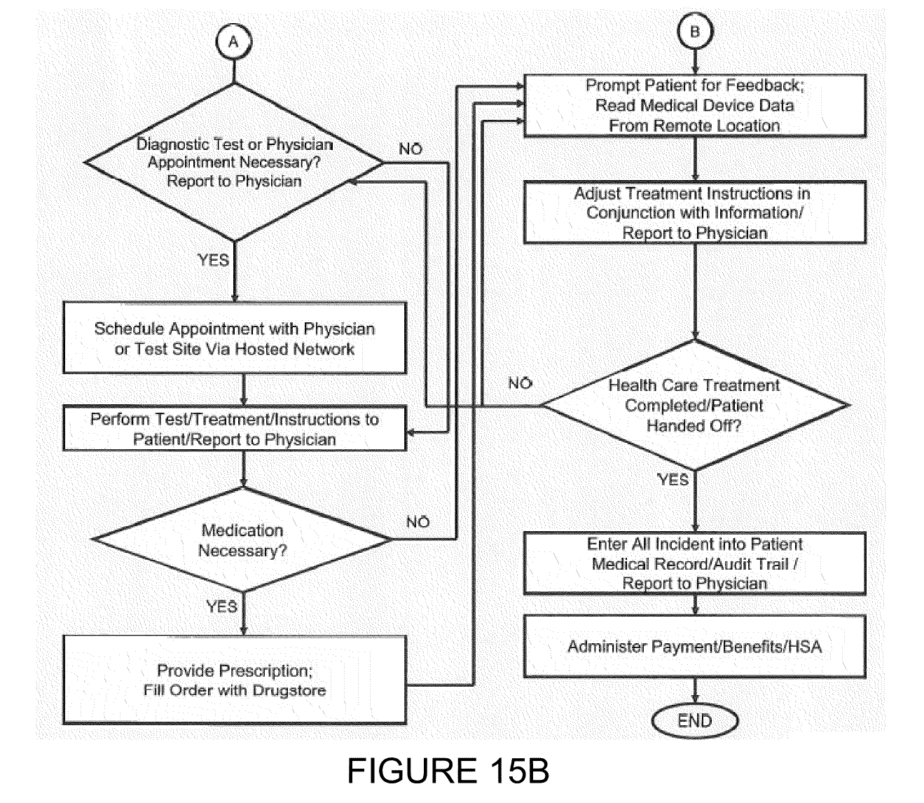

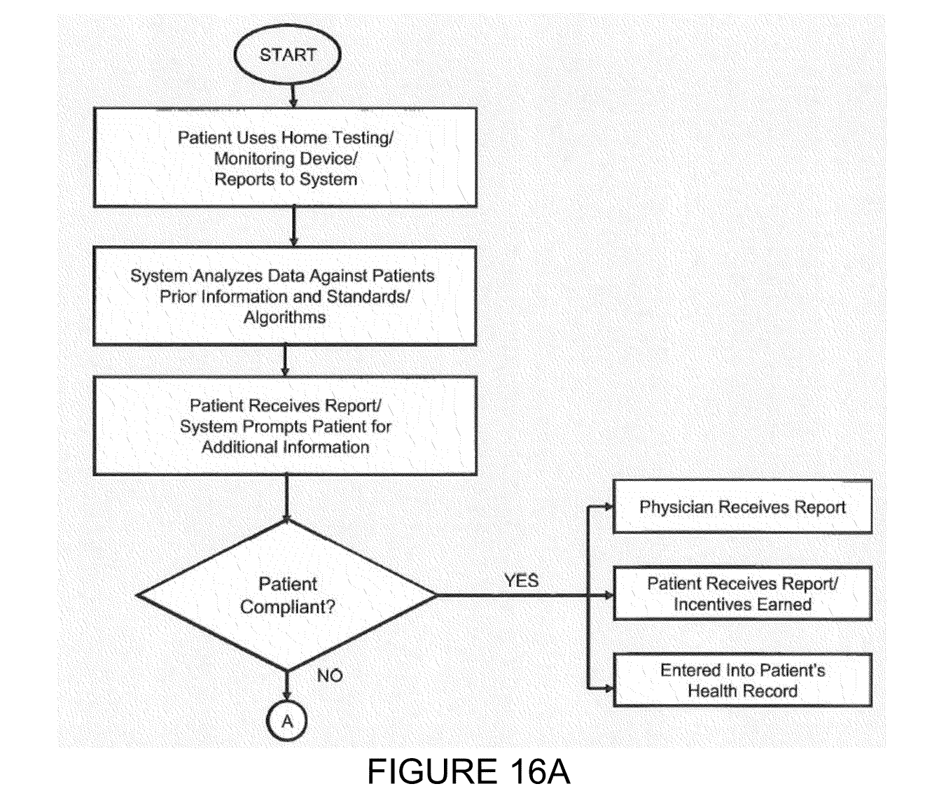

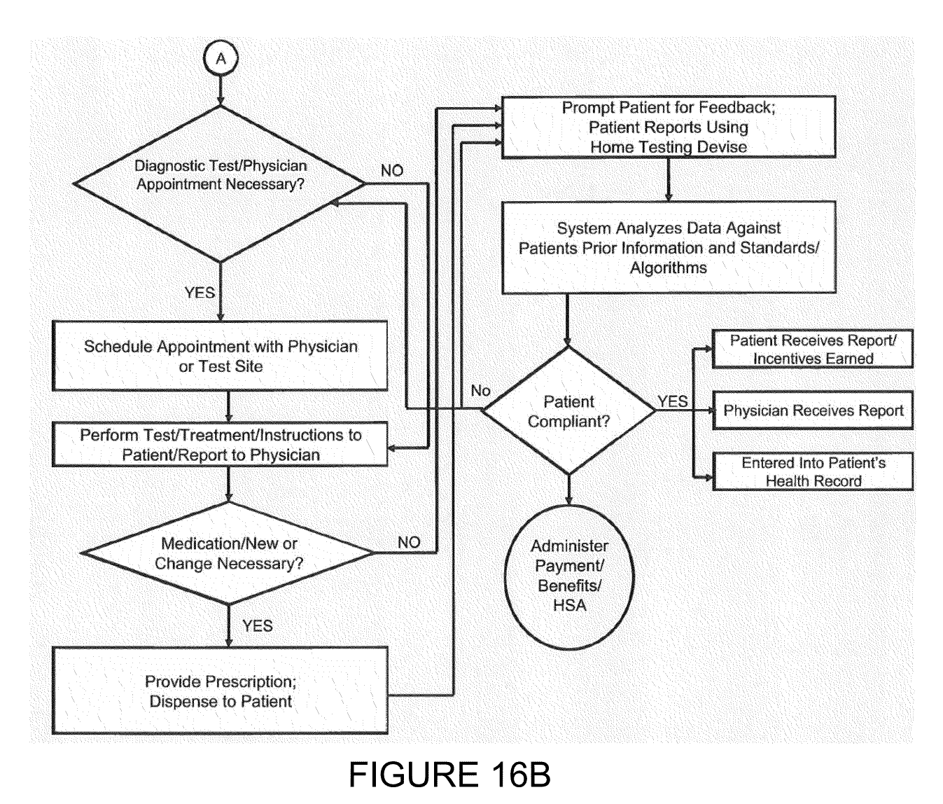

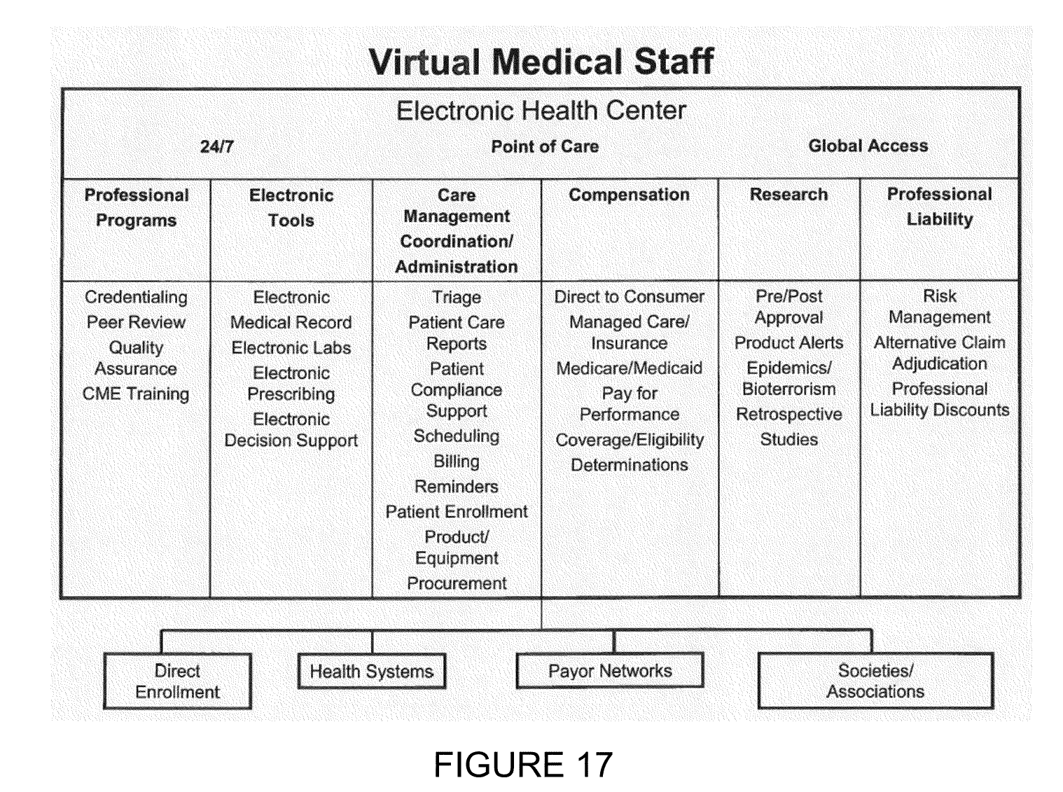

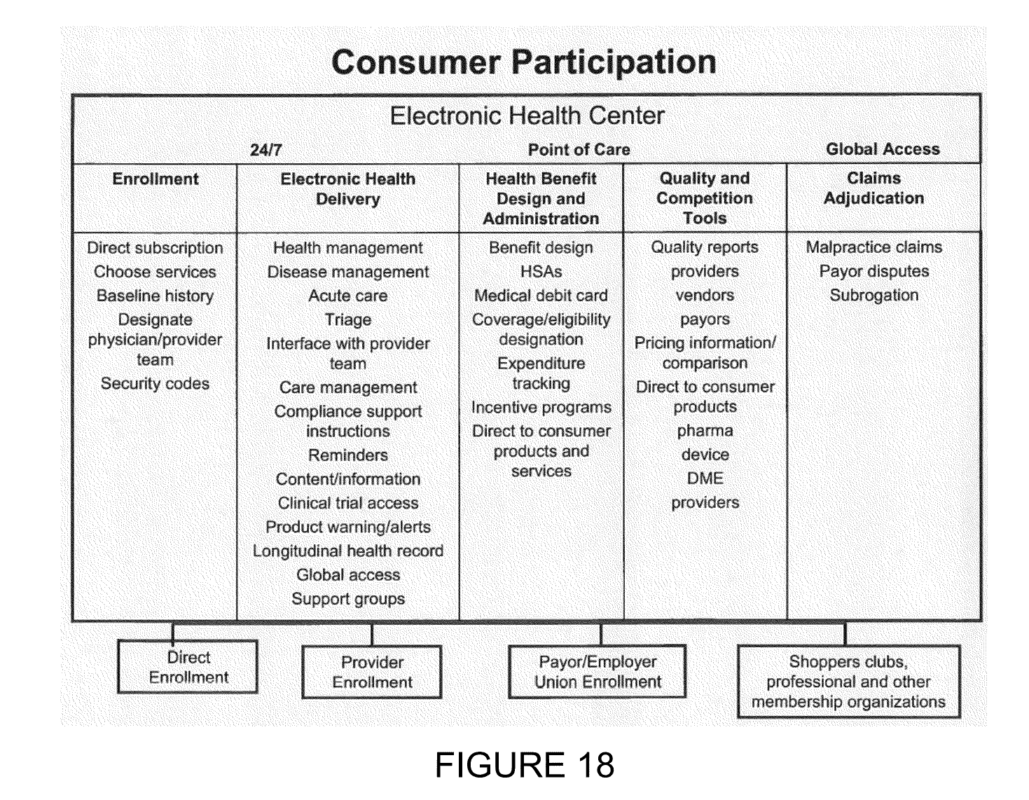

FIG. 13 illustrates another preferred embodiment of the present invention, which discloses a disease management and prescription drug benefit program. A payor pays for prescription drug and health management/compliance. A pharmacy includes rebates, online sales and advertising, formulary status and a sales force, whereas health management and compliance includes patient intervention, monitoring and education of physicians and patient incentive programs. Further, an online prescription drug benefit is provided, including hand-held computers for physicians with add-on medical devices. The hosted environment and the benefits partner interact to provide the treating physician network and patient with various financial and administrative services, as illustrated in FIG. 13.

There are many players who have a lot of interest in helping to create an infrastructure from which to launch these initiatives. For example, certain pharmaceutical companies' key marketing strategies are based upon the Internet, not primarily because they want to generate revenues via the Internet, but to maintain direct access to doctors and consumers to support their core business of developing and selling pharmaceutical products.

There are some extremely powerful information databases in existence that serve as extraordinarily predictive marketing tools. For example, every manner in which consumers use a discount card is amassed along with all the other information databases out there so that a consumer can be profiled as, for example, being a certain age, owning a motorcycle, living in a certain neighborhood, and having a certain kind of job. It can then be predicted fairly accurately the way someone is going to interface with a particular system.

While there is a market for companies such as WebMD in terms of physician-to-physician and physician-to-consumer and consumer-to-consumer education, these initiatives become much more viable if a sufficient number of treating physician and consumer participants are linked on a secure platform via the system or Community Medical Extranet.

The problem, however, is that a doctor may sign up for the service because the subscription is free, but the reality is that physicians do not have the time to review e-mails from their patients, nor are they compensated for doing so. Moreover, the potential liability for having e-mails being received by the physician without providing substantive responses is tremendous. In the end, it merely adds another layer of work on a physician and, because the physician community and health care system is so fragmented and disorganized, it does not improve health care significantly or save costs.

In light of these considerations, one of the primary challenges is to find the right incentive for meaningful physician participation. A core concept of the present invention is the creation of a truly integrated physician community in conjunction with secure portals to create a virtual or actual organization at the community level that provides the infrastructure to link the physicians to the organization cost effectively. The market requires that physicians be compensated to manage health care and, as medically appropriate, diagnose and treat patients in non-face-to-face or eye-ball to eye-ball environments. This challenge of creative physician compensation requires identifying continually standards of practice, protocols and non-face-to-face treatment diagnosis and preventive health modalities. This exemplifies the form of clinical re-engineering that the present invention encompasses. The re-engineering could be delivered through a Community Medical Extranet, focusing on medical staffs or large health systems as the best access point, where the physicians are somewhat organized and focused on giving care (rather than medical societies that are much more political entities).

The functions of a Community Medical Extranet include, but are not limited to, the role of distributing to national e-health providers and others, not just limited to the Internet. It has the potential to create a source of revenue to compensate physicians for the re-engineering and non-face-to-face patient time. In addition, it facilitates the clinical re-engineering to eliminate physicians' current face-to-face strain upon diagnosis and treatment. It also facilitates the pooling of resources as well as the care and integration concept so that physicians are really interfacing with each other. It also results in patients being better directed about how to access the system. It would also create the basis for centralizing and standardizing the collection and exchange of medical information, given that clinical re-engineering entails physicians creating and maintaining PHR in a more standardized format and reporting the appropriate key information so that the information can be pooled, sorted, and examined much more effectively. Because it has a strong consumer component, this approach will empower consumers to be much more effectively proactive in their care and treatment. This result would be better for purchasers and provide the opportunity to clinically integrate and facilitate physicians and others in playing a role, not merely in providing direct treatment but in the overall management and integration of care.

Additionally, because it will then be possible to customize the present invention to specific components of a particular patient base, it can be implemented to focus on specialty care, such as geriatric, pediatric, and periology. This also permits the creation of a tremendously powerful clinical research organization with an infrastructure that is already in place. Once there is established a disciplined, coordinated and standardized panel of physicians and their patients, it is possible to identify potential enrollees, effective self-reporting, and good receipt of the data.

National pharmaceutical companies, for example, are interested in developing knowledge about and supporting treatment of certain medical conditions or disease states through an Internet driven disease management tool interacting with physicians and patients. Such an approach can reduce the number of patients in the emergency room and keep people healthier and much more satisfied with their quality of life; however, there is no reimbursement system in place to support it. From an e-provider's perspective, the physician-driven organization of the present invention will customize and program e-products and services offered through the next generation's health system. The product of the present invention will be offered at the treating physician and consumer level by individual medical community identifiers so that patients are able to appreciate that the product relates to their personal health. This represents a very powerful distribution network. In return, the physician-driven organization receives a percent of the advertising revenues or other payment streams that are generated.

Medical centers and hospitals risk financial destruction by not participating in such an approach. Hospitals today are seeking to expand into the continuum of care. Many are acquiring physician practices and employing physicians. According to a preferred embodiment of the present invention, one function that a health system supported PDO would serve is as a clearinghouse for physician communications. In addition, the PDO would have the capacity to sort through and distribute throughout the community new developments and opportunities. In order for the product to be a viable investment, the system in place must ensure that the tools are being effectively used as a meaningful communications and delivery mechanism.

The PDO provides oversight to ensure that the tools are implemented and for the physicians' benefit, by organizing physicians to work collaboratively. It is a business-to-business function, as well as a research and development resource regarding new applications and redefined services and sources for re-engineering health care delivery. It has the capacity to validate and integrate new national products and vendors. The system enables new health delivery and reimbursement models such as ACO's, advanced medical homes, It supports health care reform by creating less costly delivery models, but also increases patient access to health care and supports patients in better managing their health care with the direct support of their medical team.

There are many different ways to generate revenues from this model. According to a preferred embodiment of the present invention, one approach is to offer a national network of vendors whereby the system assembles the participants for participation through a Community Medical Extranet. In addition, there is the potential for providing in-kind services, providing incentives to physicians using the Internet and sharing the revenue advertising. The present invention increases the advertising potential through increased number of web site visits, along with management fees, brokerage fees, research fees, administrative fees, and data analytics for disease management and other purposes.

An implementation of the present invention organizes the entire system and has a turnkey monitoring management contract with an individual Community Medical Extranet to implement the present invention. The present invention serves as an Internet PPO (preferred provider organization) offered at the Community Medical Extranet level through the administrative functions of the implementation. This Internet PPO approach effectively eliminates one of the primary impediments to integration at present: the unlicensed practice of medicine. The present invention removes the problem because the treating physician is making the decision. As a result, the patient is able to obtain a prescription by sending an e-mail request to the pharmacy for mail order delivery. Because the treating physician has been interfaced in the decision by the system, an online pharmacy that is filling the prescription has no concern about the physician's license based on where the patient is located. In addition, the patient benefits tremendously by not having to have a face-to-face visit with the physician to obtain a prescription. The PDO would oversee any service fees that are paid to the doctors and are the ones that are going to measure whether the doctor is really using the Internet disease management tools effectively and then administer those fees.

The physician payment strategy would include managed care concepts. The kind of services physicians would actually be paid for is the oversight function, the clinical re-engineering function, actual patient services, giving care, clinical research, maintaining records in such a way as to deliver meaningful data back and receiving compensation in return. The payment model would also include safety concerns, creating incentive payments that relate to actual outcomes and patient satisfaction, among other factors.

The system also promotes the creation and maintenance of a secure PHR that can be protected and audited against unauthorized use. Patients can control access and be advised when records are transmitted to others. In one embodiment, the system preserves patient confidentiality in accordance with a command signal received from said patient to determine whether to release medically relevant confidential information (including prompting the patient or user as to whether to release the medically relevant confidential information), and maintains an audit trail. The data and records maintained in the medical service bureau are encrypted to preclude disclosure of patient-specific information.

There are many venues emerging where participants in a secure Community Medical Extranet could interface. There is a sizeable roster of virtual customers for the present invention, along with clear market factors that the present invention would be in demand. A pharmaceutical company may use the present invention in conjunction with its sales force, using the Internet to obtain direct access to physicians. In addition, the PDO could agree to provide the formulary and, as part of the contract, there would be agreement not to counter-detail the company's products. See generally Slide 22. The bottom line is that the physician needs to make the best medically appropriate decision. By using the Internet PPO approach, the actual licensed physician in the community, the treating physician, makes the decision. The system enables the treating physician to participate in the development of the formulary rather than it being solely determined by the payor. The system extends the ability of treating physicians to care for patients beyond an e-mail exchange, office visits, or on-line camera visits.

It is possible to set up the present invention at a large hospital system with thousands of physicians on their medical staff so that the hospital system had one source of revenue. If the hospital system so desires, it can itself be the one that pays the physicians for the source of revenue. The hospital system itself can pay the physicians for the services that they currently perform for so that they own that piece of it. This could be designed in a multiple of ways.

While the preferred embodiment of the present invention discloses that physicians are included in the health care provider network and methods described above, the health care provider network is not limited thereto, and other qualified health care professionals may be included in the health care provider network. For example, but not by way of limitation, nurses, podiatrists, dentists, chiropractors, or other medical professionals at various levels may also be connected in similar hosted environments for various medical specializations.

The present invention has various advantages. For example, but not by way of limitation, accuracy and precision of treatment are improved due to standardization and decreased time between onset of the medical condition and commencement of treatment. Money is saved due to the decreased need for in-patient procedures, hospital beds, and the like, and the associated decrease in overhead. Further, improved participation and standardization of CRO's will lead to more accurate results, better participation, and more rapid use of safe, new medical treatments.

Additionally, the globalization of the present invention overcomes the prior art problems of time delay and increased cost in obtaining basic access, and simplifies the process of purchasing and accessing health care treatment in other countries having different languages, currencies, protocols or the like. Thus, access to health care is improved, and the overall health of participating patients is increased at a reduced cost to the patient, employer and the government.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of performing research or post-market surveillance, comprising the steps of:
enrolling, using a processor or microprocessor, a plurality of patients in an automated healthcare services network, wherein said network comprises one or more computer server machines;
automatically generating, using a processor or microprocessor, a patient profile and multigenerational family history for at least one of said plurality of patients;
automatically identifying, using a processor or microprocessor, a subset of said plurality of patients, said subset comprising patients who are candidates for a research or post-market surveillance program, wherein said identification is based at least in part on the patient profile and multigenerational family history;
inviting some or all of the candidates in the subset to participate in the research or post-market surveillance program;
enrolling some or all of the candidates who accept the invitation; and
and conducting the research or post-market surveillance.

2. The method of claim 1, further comprising the step of determining results of the research or post-market surveillance.

3. The method of claim 2, further comprising the step of automatically comparing, using a processor or microprocessor, said research or post-market surveillance results to patient profile information for some or all of said plurality of patients.

4. The method of claim 3, further comprising the step of generating a comparison result.

5. The method of claim 2, further comprising the step of documenting said research or post-market surveillance results in a database attached to or within the automated healthcare services network.

6. The method of claim 1, further comprising the steps of:
enrolling a physician or health care provider in the automated healthcare services network;
assessing the qualifications of said physician or health care provider;
evaluating the patient database of said physician or health care provider;
determining a qualification status of said physician or health care provider;
retaining said physician or health care provider for participating in the research or post-market surveillance program.

7. The method of claim 2, further comprising the steps of:
determining whether said research or post-market surveillance program produced a new medical treatment, diagnostic, or care pathway;
automatically identifying patients within the automated healthcare services network that have characteristics indicative of qualification for said new medical treatment, diagnostic, or care pathway;
offering, directly or through a physician or health care provider, said new medical treatment to patients that have said characteristics.

8. The method of claim 2, further wherein said results comprise a previously unavailable medical diagnosis, treatment, care pathway, or management technique.

9. The method of claim 1, wherein said automated healthcare services network comprises an automated sponsor network and an automated healthcare provider network,
said automated sponsor network comprises a plurality of computing devices in electronic communication with each other; and
said automated healthcare provider network comprises a plurality of computing devices in electronic communication with each other.

10. A system for providing health care services and products, comprising:
a computer processor or microprocessor coupled to a memory, wherein the processor or microprocessor is programmed to provide health care services and products by:
integrating one or more components into a health services network, said network comprising a sponsor network and a provider network;
credentialing one or more health care providers in said provider network;
monitoring said health care providers;
automatically enrolling a patient into said heath service network;
providing health care services and products for or to said patient;
automatically generating a treatment tree or care management tree comprising at least one treatment or management instruction for application to said patient;
automatically performing said at least one treatment or management instruction directly for or on said patient without prior review by a physician or health care provider; and
automatically managing health care finance benefits and options for said patient.

11. The system of claim 10, wherein said processor or microprocessor is further programmed to provide health care services and products by:
automatically generating an electronic medical history for said patient; and
generating an audit trail.

12. The system of claim 10, wherein said provider network comprises a plurality of participating, licensed health care providers.

13. The system of claim 10, wherein said sponsor network comprises a plurality of payors and one or more of sponsors, employers, pharmaceutical or medical device manufacturers, online health companies, financial institutions, information technology entities, equipment entities, software entities, service entities, or other health care entities.

14. The system of claim 10, wherein said processor or microprocessor is further programmed to provide health care services and products by:
automatically generating a diagnostic tree comprising at least one diagnosis for application to said patient.

15. A method of providing health care services and products, comprising the steps of:
providing a health services network, said network comprising a sponsor network and a provider network;
enrolling a plurality of users or patients in the health services network;
receiving, using a processor or microprocessor coupled to a computer memory, a health care services request in a standardized format having at least one parameter from a user or patient in said plurality of users or patients;
automatically performing, using a processor or microprocessor, an initial assessment of the user or patient based upon said request for health care services;
automatically generating, using a processor or microprocessor, a diagnosis of the user or patient based upon said request for health care services;
automatically generating, using a processor or microprocessor, and based upon said diagnosis, a treatment tree or care management tree comprising at least one treatment or management instruction for application to the user or patient;
automatically performing, using a processor or microprocessor, the at least one treatment or management instruction directly for or on to the user or patient, without prior review by a physician or health care provider.

16. The method of claim 15, further comprising the steps of;
generating, using a processor or microprocessor, a standardized, secure electronic medical history comprising one or more medical records for said user or patient;
generating, using a processor or microprocessor, an audit trail for any changes in said medical records;
generating, using a processor or microprocessor, a risk profile for said user or patient based in part on said electronic medical history;
designing, using a processor or microprocessor, health care finance benefits and options;
offering, using a processor or microprocessor, said health care finance benefits and options to one or more of said plurality of users or and patients; and
managing, using a processor or microprocessor, said health care finance benefits and options.

17. The method of claim 15, further comprising the steps of:
receiving, using a processor or microprocessor, at least one vital sign or symptom or other diagnostic indicator from said patient through said networked environment; and
adjusting, using a processor or microprocessor, said at least one health care treatment or management instruction based on said at least one vital sign or symptom or other diagnostic indicator.

18. The method of claim 17, wherein said receiving step comprises receiving the at least one vital sign or symptom or other diagnostic indicator through a medical or computing device or sensor positioned with said patient.

19. The method of claim 15, further comprising the steps of:
generating, using a processor or microprocessor, a personalized, secure user interface for said user or patient; and
creating, using a processor or microprocessor, a risk profile by performing genetic tests to map the genes of said user or patient and reviewing said user or patient's genetic history via a family tree.
